(19) United States
(12) Patent Application Publication
(10) Pub. No.: US 2025/0334123 A1
(43) Pub. Date: Oct. 30, 2025

(54) Fluid Compressor Device

(71) Applicant: Garrett Transportation I Inc., Torrance, CA (US)

(72) Inventors: John Poomkuzhimannil, Bangalore (IN); Praveen Kumar, Bangalore (IN)

(73) Assignee: Garrett Transportation I Inc., Torrance, CA (US)

(21) Appl. No.: 18/648,546

(22) Filed: Apr. 29, 2024

(51) Int. Cl. F04D 25/06; F04D 29/057

(52) U.S. Cl. CPC F04D 25/0606; F04D 29/057

(57) ABSTRACT

Disclosed is a fluid compressor device for compressing fluid comprising a motor housing, a compressor housing, rotatable group extending along an axis of rotation from the motor housing central chamber into the compressor housing, and comprising a magnet and a compressor wheel, and various structures, fluid flow paths, and shapes.

### FIELD OF THE INVENTION

The present disclosure relates to fluid compressor devices for air conditioning systems.

### BACKGROUND OF THE INVENTION

Air conditioning systems include, in series, a compressor for compressing a working fluid, a first heat exchanger for removing heat from the hot compressed working fluid, an expansion region where the compressed fluid expands and cools, and a second heat exchanger for absorbing into the cooled working fluid heat from the surrounding environment. U.S. Pat. Nos. 8,061,151 and 8,931,304 disclose fluid compressor devices that include a stator.

Garrett docket number G001282, first filed Feb. 21, 2023, and accorded U.S. application Ser. No. 18/171,724, is directed to working fluid flow paths and bearing cooling for compressor devices, and is related to this application.

### OBJECT OF THE INVENTION

Objects of the invention are to provide fluid compressor devices with increased reliability, efficiency, and compactness.

### SUMMARY OF THE INVENTION

In one aspect, the disclosure provides a novel fluid compressor device for compressing fluid, comprising: a motor housing having a motor housing rear end and a motor housing front end, and motor housing side surfaces, the motor housing defining a motor housing central chamber; a compressor housing having a compressor housing rear end and a compressor housing front end; wherein the motor housing front end faces the compressor housing rear end; wherein the motor housing and the compressor housing are immovably fixed to one another; a motor stator section in the motor housing central chamber; a rotatable group extending along an axis of rotation from the motor housing central chamber into the compressor housing; wherein the rotatable group is rotatable about the axis of rotation; wherein the rotatable group comprises a compressor wheel in the compressor housing and a magnet in the motor housing; wherein the compressor wheel and magnet are constrained to rotate together as the rotatable group rotates; wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber; wherein the motor housing and the compressor housing are configured to provide an internal path for fluid to flow from the motor housing central chamber to a compressor housing inlet port on a surface of the compressor housing rear end; wherein the compressor housing is configured to provide a primary flow outlet path for fluid to flow from the compressor housing inlet port through a compressor conduit to a surface of the compressor wheel, past the surface of the compressor wheel to a volute region, from the volute region into a compressor outlet conduit, and from the compressor outlet conduit through a compressor outlet port to outside fluid compressor device.

The disclosure provides the novel fluid compressor device may incorporate one or more of the following features: wherein the motor housing front end defines a motor housing front surface; wherein the motor housing front surface has a relatively flat motor housing front surface region and a groove surface region; wherein the relatively flat motor housing front surface region is relatively flat compared to the groove surface region; wherein the groove surface region is enclosed by the motor housing front surface region; wherein the groove surface region defines a groove; wherein the groove has a groove perimeter where the groove surface region meets the relatively flat motor housing front surface region; wherein the groove perimeter extends further in a polar, that is azimuthal, direction around the axis of rotation than in a radial direction away from the axis of rotation; wherein the groove surface region encloses at least two partial primary flow outlet ports in the groove; wherein each one of the at least two partial primary flow outlet ports extends to a corresponding one of at least two partial primary flow conduits; wherein each one of the at least two partial primary flow conduits extends to a corresponding one of at least two partial primary flow inlet ports; and wherein each one of the at least two partial primary flow inlet ports opens to the motor housing central chamber.

The disclosure provides the novel fluid compressor device may incorporate one or more of the following features: wherein the groove surface region encloses four partial primary flow outlet ports in the groove; wherein the groove surface region encloses six partial primary flow outlet ports in the groove; wherein the groove perimeter has a groove perimeter inner edge, and the groove perimeter inner edge defines an inner arc at an inner arc radius from the axis of rotation, and the groove perimeter has a groove perimeter outer edge, and the groove perimeter outer edge defines an arc at an outer arc radius from the axis of rotation; and wherein the outer arc radius is greater than the inner arc radius.

The disclosure provides the novel fluid compressor device may incorporate one or more of the following features: wherein the compressor conduit extends from the compressor housing inlet port to a forward axial location, wherein the forward axial location is forward of an axial location of the compressor wheel and forward of an axial location of the volute region; wherein the compressor conduit extends from the forward axial location to a compressor conduit eye, which is where compressor conduit faces the surface of the compressor wheel; wherein the compressor housing inlet port has a compressor housing inlet port cross-sectional area; wherein the compressor conduit has a compressor conduit eye length, which is length along a center-curve in the compressor conduit from the compressor housing inlet port to the compressor conduit eye; and wherein a cross-sectional area of the compressor conduit at a point 85 percent of a way along the compressor conduit eye length from the compressor housing inlet port, divided by the compressor housing inlet port cross-sectional area, is within plus or minus 30 percent of 0.366.

The disclosure provides the novel fluid compressor device may incorporate one or more of the following features: wherein a cross-sectional area of the compressor conduit at a point 50 percent of a way along the compressor conduit eye length from the compressor housing inlet port, divided by the compressor housing inlet port cross-sectional area, is within plus or minus 30 percent of 1.43; wherein a cross-sectional area of the compressor conduit at a point 25 percent of a way along the compressor conduit eye length from the compressor housing inlet port, divided by the compressor housing inlet port cross-sectional area, is within plus or minus 30 percent of 2.3; wherein a cross-sectional area of the compressor conduit at a point 85 percent of a way along the compressor conduit eye length from the compressor housing inlet port, divided by the compressor housing inlet port cross-sectional area, is within plus or minus 20 percent of 0.366; wherein a cross-sectional area of the compressor conduit at a point 50 percent of a way along the compressor conduit eye length from the compressor housing inlet port, divided by the compressor housing inlet port cross-sectional area, is within plus or minus 20 percent of 1.43; and wherein a cross-sectional area of the compressor conduit at a point 25 percent of a way along the compressor conduit eye length from the compressor housing inlet port, divided by the compressor housing inlet port cross-sectional area, is within plus or minus 20 percent of 2.3; wherein a cross-sectional area of the compressor conduit at a point 85 percent of a way along the compressor conduit eye length from the compressor housing inlet port, divided by the compressor housing inlet port cross-sectional area, is within plus or minus 10 percent of 0.366; wherein a cross-sectional area of the compressor conduit at a point 50 percent of a way along the compressor conduit eye length from the compressor housing inlet port, divided by the compressor housing inlet port cross-sectional area, is within plus or minus 10 percent of 1.43; and wherein a cross-sectional area of the compressor conduit at a point 25 percent of a way along the compressor conduit eye length from the compressor housing inlet port, divided by the compressor housing inlet port cross-sectional area, is within plus or minus 10 percent of 2.3; wherein the compressor housing inlet port has a cross-section that is arcuate; wherein the motor housing front end defines a motor housing front surface that includes a groove surface region that defines a groove having a groove perimeter, and wherein the groove perimeter and a perimeter of the compressor housing inlet port have a same shape, and the groove and the compressor housing inlet port mate to one another

The disclosure provides the novel fluid compressor device may incorporate one or more of the following features: wherein the compressor inlet conduit extends from the compressor housing inlet port to a forward axial location, wherein the forward axial location is forward of an axial location of the compressor wheel and forward of an axial location of the volute region; wherein the compressor inlet conduit extends from the forward axial location to a compressor conduit eye, which is where compressor inlet conduit faces the surface of the compressor wheel; wherein the compressor conduit has a compressor conduit eye length, which is length along a center-curve in the compressor conduit from the compressor housing inlet port to the compressor conduit eye; wherein a volute region to conduit distance is a minimum distance between a surface of the volute region and a surface of the compressor conduit; and wherein the compressor conduit eye length, divided by the volute region to conduit distance, is between plus or minus 30 percent of 7.76.

The disclosure provides the novel fluid compressor device may incorporate one or more of the following features: wherein the compressor conduit eye length, divided by the volute region to conduit distance, is between plus or minus 20 percent of 7.76.; wherein the compressor conduit eye length, divided by the volute region to conduit distance, is between plus or minus 10 percent of 7.76; wherein a smallest volute region to conduit distance is a minimum distance between the compressor conduit and a smaller section of the volute region; and wherein the compressor conduit eye length, divided by the smallest volute region to conduit distance, is between plus or minus 30 percent of 4.85; wherein the compressor conduit eye length, divided by the smallest volute region to conduit distance, is between plus or minus 30 percent of 4.85; wherein the compressor conduit eye length, divided by the smallest volute region to conduit distance, is between plus or minus 30 percent of 4.85.

The disclosure provides the novel fluid compressor device may incorporate one or more of the following features: wherein the internal path comprises at least one primary flow outlet port that opens to the motor housing central chamber at a location that is forward of the primary flow internal port; wherein the compressor conduit extends from the compressor housing inlet port to a forward axial location, wherein the forward axial location is forward of an axial location of the compressor wheel and forward of an axial location of the volute region; wherein the compressor conduit extends from the forward axial location to a compressor conduit eye, which is where compressor conduit faces the surface of the compressor wheel; further comprising structure defining a secondary flow path for fluid flow passing from a front end of a first seal to a rear end of the first seal;
wherein the front end of the first seal is rear of where the compressor conduit faces the surface of the compressor wheel; wherein the first seal is defined by opposing surface of a first seal part and a second seal part, wherein the first seal part is part of the rotating group and is constrained to rotate with the rotating group and the second seal part is a non-rotating seal part that does not rotate; wherein a first branch of the secondary flow path extends from the rear end of the first seal to a front end of a front radial fluid bearing, through the front radial fluid bearing, and to a rear end of the front radial fluid bearing which opens to the motor housing central chamber; wherein a second branch of the secondary flow path extends from the first seal to a rear end of a rear radial fluid bearing, through the rear radial fluid bearing, to a front end of the rear radial fluid bearing which opens to the motor housing central chamber; and wherein the rear radial fluid bearing is closer to the motor housing rear end than the front radial fluid bearing.

The disclosure provides the novel fluid compressor device may incorporate one or more of the following features: wherein the first seal defines a labyrinth seal; wherein the secondary flow path passes through a chamber containing a rotatable thrust fluid bearing; wherein the rotatable thrust fluid bearing is a part of the rotating group and is constrained to rotate with the rotatable group, and wherein the secondary flow path passes through the chamber containing the rotatable thrust fluid bearing before branching into the first branch and the second branch.

The disclosure provides the novel fluid compressor device may incorporate one or more of the following features: wherein the compressor housing front end comprises a compressor housing end cap; wherein the compressor housing end cap comprises a plurality of compressor housing end cap radially extended regions; wherein the compressor housing rear end comprises a plurality of compressor housing rear end radially extended regions; wherein the motor housing front end comprises a plurality of motor housing front end radially extended regions; wherein a first one of the plurality of compressor housing end cap radially extended regions has a surface region that defines a first end cap fastener region; wherein the first end cap fastener region forms either an aperture or a recess extending along a first fastener axis; wherein the first fastener axis is parallel to the axis of rotation; wherein a first one of the plurality of compressor housing rear end radially extended regions has a surface region that defines a first compressor housing rear end fastener region; wherein the first compressor housing fastener rear end fastener region forms an aperture extending along the first fastener axis; wherein a first one of the plurality of motor housing front end radially extended regions has a surface region that defines a first motor housing front end fastener region; and wherein the first motor housing front end fastener region defines either an aperture or recess extending along the first fastener axis.

The disclosure provides the novel fluid compressor device may incorporate one or more of the following features: further comprising a first fastener extending within the first end cap fastener region, the first compressor housing rear end fastener region, and the first motor housing front end fastener region; wherein a second one of the plurality of compressor housing end cap radially extended regions has a surface region that defines a second end cap fastener region; wherein the second end cap fastener region forms either an aperture or a recess extending along a second fastener axis; wherein the second fastener axis is parallel to the axis of rotation; wherein a second one of the plurality of compressor housing rear end radially extended regions has a surface region that defines a second compressor housing rear end fastener region; wherein the second compressor housing fastener rear end fastener region forms an aperture extending along the second fastener axis; wherein a second one of the plurality of motor housing front end radially extended regions has a surface region that defines a second motor housing front end fastener region; wherein the second motor housing front end fastener region defines either an aperture or recess extending along the second fastener axis; and further comprising a second fastener extending within the second end cap fastener region, the second compressor housing rear end fastener region, and the second motor housing front end fastener region.

The disclosure provides the novel fluid compressor device may incorporate one or more of the following features: wherein the compressor wheel comprises a vane; wherein the vane comprises front edge; wherein the front edge of the vane sweeps across a surface that defines an annular compressor wheel inlet, when the compressor wheel rotates 360 degrees; wherein the compressor conduit extends from the compressor housing inlet port to a forward axial location, wherein the forward axial location is forward of an axial location of the compressor wheel and forward of an axial location of the volute region; wherein the compressor conduit extends from the forward axial location to the annular compressor wheel inlet; wherein the compressor conduit comprises a compressor inlet conduit portion and an annular compressor housing conduit portion; wherein the compressor inlet conduit portion extends from the compressor housing inlet port to a merger location with the annular compressor housing conduit portion such that a path within the compressor conduit exists from the compressor inlet conduit portion into the annular compressor housing conduit portion; wherein the compressor inlet conduit portion has an azimuthal extent about the axis of rotation that is less than one circle, that is less than 360 degrees; and wherein the annular compressor housing conduit portion has an azimuthal extent about the axis of rotation that is one circle, that is equal to 360 degrees.

The disclosure provides the novel fluid compressor device may incorporate one or more of the following features: wherein, in a section of the fluid compressor device passing through the axis of rotation and through compressor housing inlet port, the merger location is less than 79.9 percent of a distance along a center-curve extending through the compressor conduit from the compressor housing inlet port to the annular compressor wheel inlet; wherein, in a section of the fluid compressor device passing through the axis of rotation and through compressor housing inlet port, the merger location is less than 45.2 percent of a distance along a center-curve extending through the compressor conduit from the compressor housing inlet port to the annular compressor wheel inlet; wherein, in a section of the fluid compressor device passing through the axis of rotation and through compressor housing inlet port, the merger location is less than 22.6 percent of a distance along a center-curve extending through the compressor conduit from the compressor housing inlet port to the annular compressor wheel inlet; wherein, in a section of the fluid compressor device passing through the axis of rotation and through compressor housing inlet port, the merger location is at least 5 percent of a distance along a center-curve extending through the compressor conduit from the compressor housing inlet port to the annular compressor wheel inlet; wherein, a cross-sectional area of the annular compressor housing conduit portion at a distance 79.9 percent of a distance along a center-curve extending through the compressor conduit from the compressor housing inlet port to the annular compressor wheel inlet, divided by the area of annular compressor wheel inlet, is within plus or minus 30 percent of 3.77; wherein, a cross-sectional area of the annular compressor housing conduit portion at a distance 45.2 percent of a distance along a center-curve extending through the compressor conduit from the compressor housing inlet port to the annular compressor wheel inlet, divided by the area of annular compressor wheel inlet, is within plus or minus 30 percent of 14.8; wherein, a total cross-sectional area of all compressor conduits in the compressor housing extending from inlet ports communicating from the motor housing to the annular compressor wheel inlet at a distance 22.6 percent of a distance along a center-curve extending through the compressor conduit from the compressor housing inlet port to the annular compressor wheel inlet, divided by the area of annular compressor wheel inlet, is within plus or minus 30 percent of 22.6.

Each of the foregoing aspects, features, and disclosures can be combined with any of the other aspects, features and disclosures.

### BRIEF DESCRIPTION OF THE FIGURES

The disclosure is described in conjunction with the following drawing figures, wherein like reference numerals denote the same or like elements.

FIG. 1 is a schematic showing a portion of vehicle 1 including a conventional closed fluid system for providing air conditioning to vehicle 1.

FIG. 2 is a perspective view of novel fluid compressor device 20 showing most of the top, left side, and front exterior surfaces, along with axis 25, with the front exterior surface including the exterior surface of compressor housing end cap 24 and the left exterior surface including bulged surface region 38.

FIG. 3 is perspective view of novel fluid compressor device 20 showing most of the top, right side, and front exterior surfaces of novel fluid compressor device 20.

FIG. 4 is a front view of novel fluid compressor device 20 showing the front end of the novel fluid compressor device 20, and identifying section views I-I, II-II, IV-IV, and V-V, which are shown respectively in FIGS. 11, 13, 17, and 18.

FIG. 5 a top view of novel fluid compressor device 20 showing the top surface, and having the front side at the bottom of the figure.

FIG. 6 a left side view of novel fluid compressor device 20, and identifying section view III-III, which is shown in FIG. 14.

FIG. 7 is a right-side view of novel fluid compressor device 20.

FIG. 8 is a back view of novel fluid compressor device 20.

FIG. 9 is a perspective view of novel fluid compressor device 20 showing most of the bottom side, left side, and front side.

FIG. 10 is a bottom view of novel fluid compressor device 20.

FIG. 11 is a section view of novel fluid compressor device 20 in the plane defined by section view “I-I” in FIG. 4, passing through axis 25.

FIG. 12 is a magnified view of the dashed circled region shown in FIG. 11.

FIG. 13 is a section view of novel fluid compressor device 20 in the plane defined by section view “II-II” in FIG. 4, passing through axis 25.

FIG. 14 is a section view of novel fluid compressor device 20 in the plane defined by section view “III-III” in FIG. 6, which is a plane that intersects with compressor housing 23.

FIG. 15 is front view of novel fluid compressor device 20, in which the compressor housing, the compressor housing end cap, and O-rings are hidden, exposing front surface 94 of motor housing 22.

FIG. 16 is a perspective view of compressor housing 23 of the novel fluid compressor device 20, showing rear surface 107 of compressor housing 23 (which is the surface facing motor housing 22), and oriented so that the top of compressor housing 23 appears on the left side of the figure, and the left side of compressor housing 23 appears at the top of the figure.

FIG. 17 is a section view of novel fluid compressor device 20 in the plane defined by section view “IV-IV” in FIG. 4, passing through axis 25.

FIG. 18 is a section view of novel fluid compressor device 20 in the plane defined by section indicators “V-V” in FIG. 4, passing through axis 25.

FIG. 19 is a magnified portion of the lower left side of the section shown in FIG. 11.

### DETAILED DESCRIPTION OF THE FIGURES

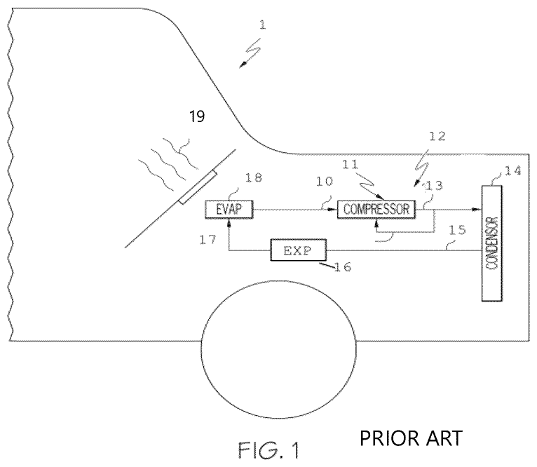

FIG. 1 illustrates a vehicle environment in which compressor devices are used. Other environments which compressor devices may be used include any form of land or airborne vehicle, buildings, and portable devices. FIG. 1 shows front end of a vehicle 1, such as a passenger car having an air conditioning system 19 and a conventional fluid system 12 for heating and cooling of a fluid. The fluid system 12 comprises conduit 10, compressor 11, conduit 13, condenser 14, conduit 15, expander 16, conduit 17, and evaporator 18.

The condenser 14 is designed to exhaust heat from the fluid to the environment, that is away from a passenger compartment of vehicle 1. The passenger compartment of vehicle 1 is designed to transmit heat from air conditioning system 19 to the fluid in evaporator 18.

In operation of system 12, relatively cool and low-pressure fluid in conduit 10 is sucked into a low-pressure region of compressor 11, and compressor 11 compresses, pressurizes, and heats the fluid creating a high-pressure region in compressor 11, which forces fluid from the high-pressure region out of compressor 11 and into conduit 13. The fluid flows through conduit 13 to condenser 14 where the fluid is condensed by removal of heat. Condensed fluid 12 flows from condenser 14 along conduit 15 to expander 16. Expander 16 expands the working fluid, thereby further cooling the fluid. The cooled fluid flows through conduit 17 into evaporate 18. FIG. 1 shows the fluid flow along a primary flow paths of compressor 11.

A primary flow path means a path through which a majority of flux of fluid enters a compressor into a low-pressure region in a compressor, and also a flow path through which a majority of flux of fluid exits the compressor from a high-pressure region in the compressor, during normal operation.

Normal operation refers to operation of the compressor when the fluid is flowing through the primary flow inlet and outlet and the compressor is compressing fluid flowing therethrough.

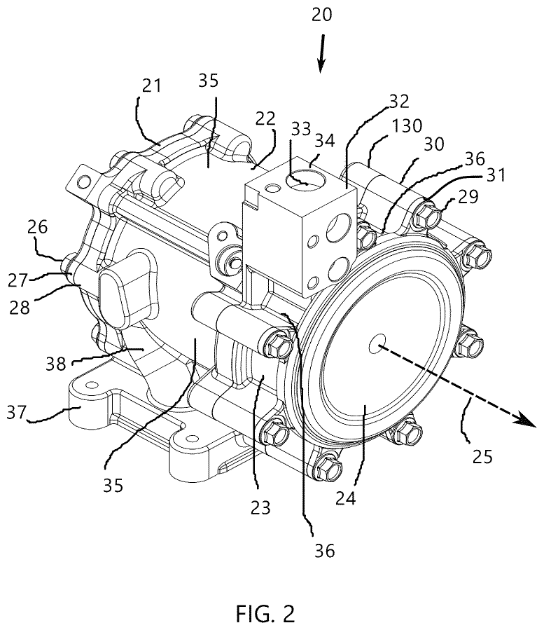

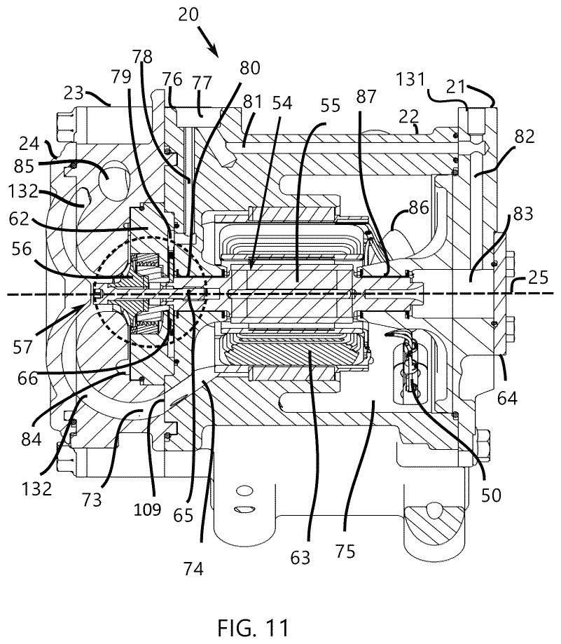

FIGS. 2-19 show views of an embodiment derived from a solid model, and therefore portray fine details. However, the horizontal and vertical dimensions in these figures may be distorted due small variations in horizontal and vertical magnification in the process of preparing these figures. Various modifications and alternatives contemplated by the inventor follow description of the embodiment portrayed by FIGS. 2-19. FIGS. 11, 13, 17, and 18 show many small black circles indicating cross-sections of O-rings. An O-ring is formed from elastomer material in the shape of a ring. O-rings are positions in regions between opposing surfaces that are configured so that the O-ring presses against those surfaces and thereby provides a seal that completely prevents fluid passage parallel to the opposing surfaces, except for an inconsequential amount, compared to primary flow, of fluid flux resulting from diffusion of fluid through the elastomer. O-rings form fluid tight seals in a manner well known in the art.

FIG. 2 shows novel fluid compressor device 20 comprising motor housing end piece 21, motor housing 22, compressor housing 23, and compressor housing end cap 24. Axis 25 identifies an axis of rotation for motor and compressor elements. Axis 25 includes an arrow head identifying a forward direction along axis or rotation 25 which, for example, indicates compressor housing 23 is forward of motor housing 22.

Compressor housing end cap 24 is located at a front end of compressor housing 23.

Fastener 26 (bolt or nut and bolt combination, or the like) extends through an aperture in radially extended region of portion 27 of motor housing end piece 21 and into a cavity or aperture in radially extended region 28 of motor housing 22. Several fasteners, similar to fastener 26, and like apertures and/or recesses, are arranged around the outer periphery (relative to axis 25) of opposing surfaces of motor housing end piece 21 and motor housing 22 to immovably secure them to one another.

Fastener 29 (bolt or nut and bolt combination, or the like) passes through an aperture in radially extended region 31 of compressor housing end cap 24, through an aperture in radially extended region 30 of compressor housing 23, and into or through a recess or aperture in radially extended region 130 of motor housing 22. Several fasteners similar to fastener 29, and like apertures and/or recesses, are distributed about the radially outer periphery (relative to axis 25) of opposing surfaces of compressor housing end cap 24, compressor housing 23, and motor housing 22 to immovably secure them to one another.

Compressor housing 23 has surfaces defining generally rectangular prism shaped section 32. Compressor outlet conduit 33 terminates in a top surface of generally rectangular prism shaped section 32 at compressor outlet port 34.

Motor housing 22 has surfaces defining cylindrical outer surface regions 35 having a constant radius relative to axis 25.

Motor housing 22 defines bulged surface region 38 bulging from cylindrical outer surface regions 35.

Compressor housing 23 has surfaces defining cylindrical outer surface regions 36 having a constant radius relative to axis 25.

Generally rectangular prism shaped section 32 extends to a distance away from axis 25 that is greater than the constant radius of cylindrical outer surface regions 36.

Motor housing 22 includes base portion 37.

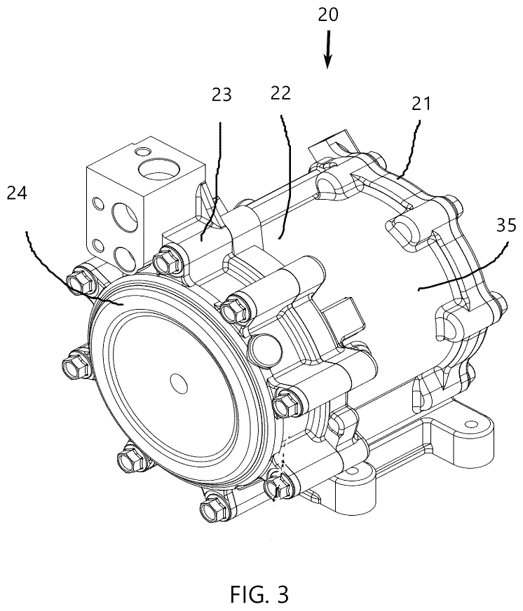

FIG. 3 shows an additional one of outer surface regions 35 on the right side of novel fluid compressor device 20.

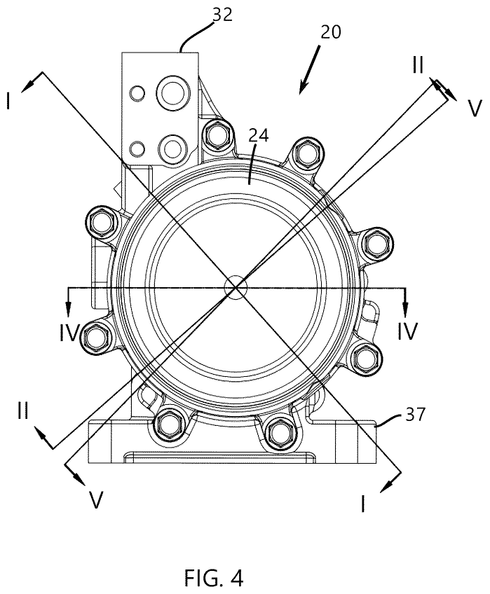

FIG. 4 is a view along axis 25 of the front of novel fluid compressor device 20, that is a view showing the outer surface of compressor housing end cap 24, identifying sections I, II, IV, and V shown respectively in FIGS. 11, 12, 16, and 17.

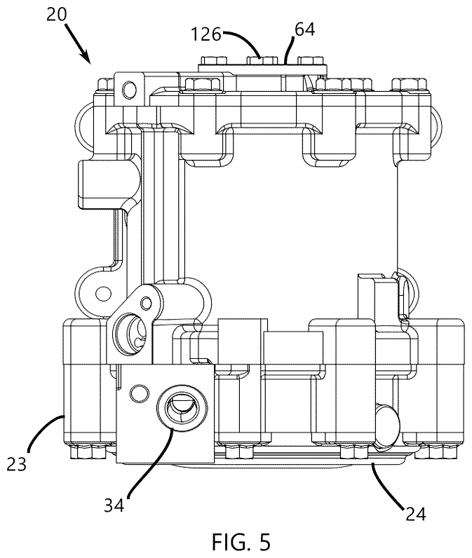

FIG. 5 a top view along a line of sight perpendicular to axis 25 showing the top surface of the novel fluid compressor device 20, including compressor outlet port 34 of compressor housing 23, motor housing end cap 64, and fasteners 126. Fasteners 126 fasten motor housing end cap 64 to motor housing end piece 21.

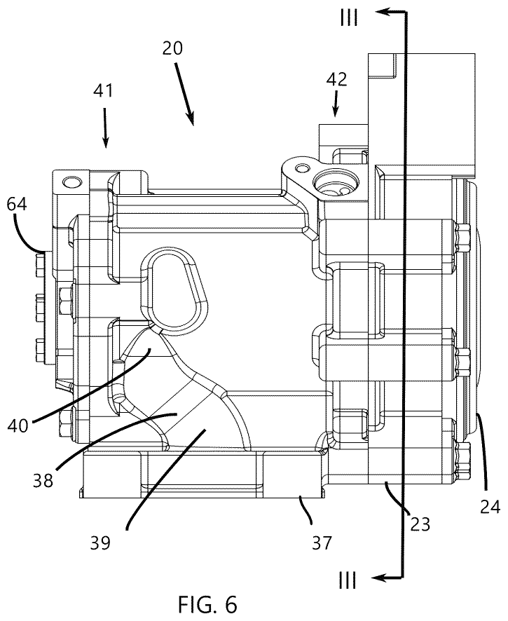

FIG. 6 is a left side view along a line of sight perpendicular to axis 25 showing the left side surface of the novel fluid compressor device 20. FIG. 6 shows bulged surface region 38 includes bulged lower portion 39 and bulged upper portion 40. Bulged surface region 38 extends from bulged lower portion 39 at a top of base portion 37 upward and to the left in FIG. 6, that is upwards and towards rear end 41 of motor housing 22 joining to bulged upper portion 40. Bulged upper portion 40 is closer to a rear end 41 of motor housing 22 than to front end 42 of motor housing 22.

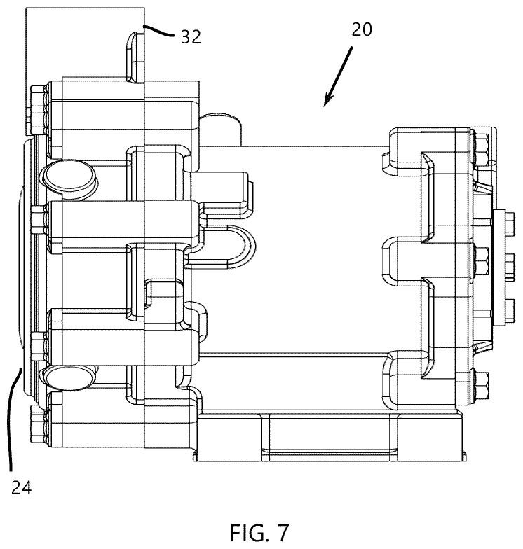

FIG. 7 shows a right side of the novel fluid compressor device 20, along a line of sight perpendicular to axis 25.

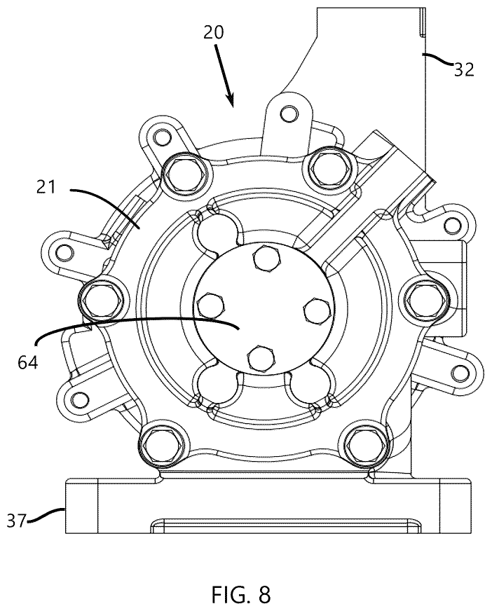

FIG. 8 is a back view of novel fluid compressor device 20, along a line of sight parallel to axis 25. FIG. 8 shows the back surface of the motor housing including motor housing end piece 21 and motor housing end cap 64.

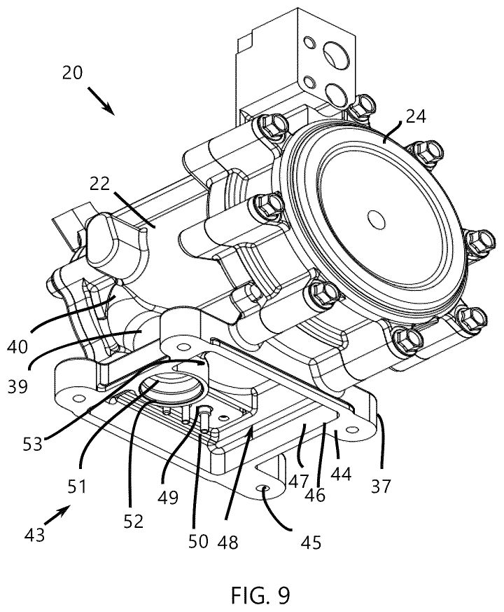

FIG. 9 is a perspective view showing most of the bottom side, left side, and front, of the novel fluid compressor device 20. FIG. 9 shows an underside 43 of base portion 37 of motor housing 22 defining bottom surface 44. Mounting apertures 45 extend through bottom surface 44. Bottom surface 44 delimits internal sidewall perimeter 46 from which upwardly extends vertical sidewall 47, thereby defining recessed region 48 of underside 43.

Feedthrough apertures 49 in recessed region 48 extend to an interior region within motor housing 22. Electrical feedthroughs 50 reside in feedthrough apertures 49.

Primary flow inlet conduit 51 of motor housing 22 extends from underside 43 to primary flow inlet port 52. A terminal portion of fluid inlet conduit terminating at primary flow inlet port 52 has outer surfaces in recessed region 48 defined by portions 53 of vertical sidewall 47. Primary flow inlet conduit 51 extends within regions of motor housing 22 defined by bulged lower portion 39 and bulged upper portion 40.

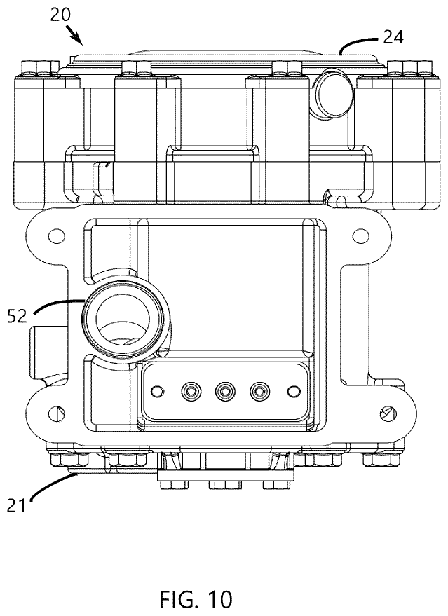

FIG. 10 shows a bottom of novel fluid compressor device 20 in which motor housing end piece 21 is at the bottom of the figure.

FIG. 11 is a view of the section identified by I-I in FIG. 4 passing through axis 25.

FIG. 11 shows rotatable group 54 that consists of elements constrained to rotate together, and stationary or non-rotating elements. The stationary elements include motor stator section 63, motor housing end cap 64, motor housing 22, compressor housing 23, compressor housing end cap 24, and diffuser plate 62.

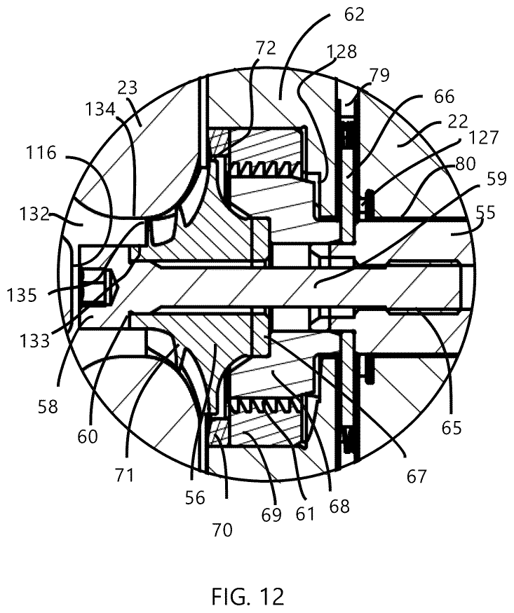

FIG. 11 shows elements of rotatable group 54 include motor rotor section 55, compressor wheel 56, bolt 57, and rotatable thrust fluid bearing 66. FIG. 12 identifies additional elements of rotatable group 54.

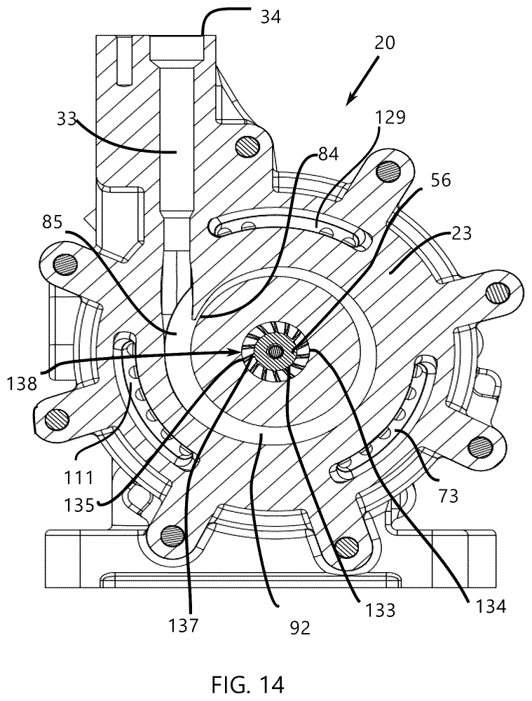

FIG. 11 shows part of primary flow internal port 86 of primary flow inlet conduit 51, central chamber 75 in motor housing 22, outlet conduit 74 of motor housing 22, compressor inlet conduit 73, annular compressor housing conduit 132, smaller section 84 and larger section 85 of volute region 92 (see FIG. 14), and arcuate inlet port 109 of compressor housing 23.

FIG. 11 shows motor stator section 63 resides within central chamber 75. Primary flow internal port 86 opens to central chamber 75 at a location further toward the rear of motor housing 22 than the rear of motor stator section 63.

Arcuate inlet port 109 is defined by edges formed where a rear exterior surface of compressor housing 23 meets compressor inlet conduit 73.

FIG. 11 shows an end of compressor inlet conduit 73 that faces motor housing 22 at arcuate inlet port 109.

Compressor inlet conduit 73 extends from arcuate inlet port 109 towards the front. Compressor inlet conduit 73 merges with compressor inlet conduit 111 and compressor inlet conduit 129 to form annular compressor housing conduit 132. The compressor conduit includes a compressor inlet conduit portion and an annular compressor housing conduit portion. The compressor conduit that includes compressor inlet conduit 73 and annular compressor housing conduit 132 extends along a path that passes volute region 92 at a distance from axis of rotation 25 that is further than a distance from axis of rotation 25 to volute region 92. That is, a compressor conduit in compressor housing 23 extends axially along axis of rotation 25 past the axial location of volute region 92, a further distance from axis of rotation 25 than volute region 92.

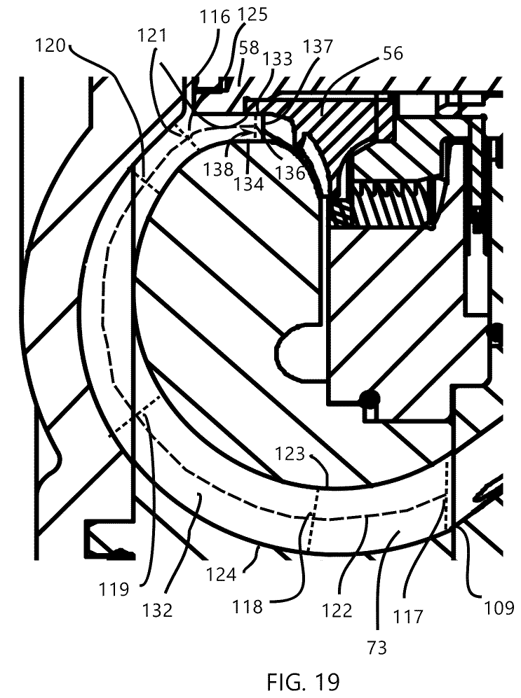

Compressor conduit eye 125 (see FIG. 19) faces compressor wheel 56 such that there is line of site within the path of fluid flow from compressor conduit eye 125 to compressor wheel 56. Annular compressor housing conduit 132 executes a U-turn so that in the region of annular compressor housing conduit 132 from compressor conduit eye 125 to annular compressor wheel inlet 138 (see FIG. 19), that is on the far side of compressor wheel 56 from motor housing 22, the direction of fluid flow in annular compressor housing conduit 132 extends axially back toward motor housing 22. A compressor conduit path extends through compressor inlet conduit 73 and annular compressor housing conduit 132, from arcuate inlet port 109 to annular compressor wheel inlet 138.

The compressor conduit path wraps around an opposing portion of volute region 92 so that fluid flowing into from the compressor inlet conduit path at arcuate inlet port 109 initially has a velocity component along the positive direction of axis of rotation 25, whereas fluid flowing in the compressor conduit path from compressor conduit eye 125 to annular compressor wheel inlet 138 has a velocity direction substantially along the negative direction of axis of rotation 25.

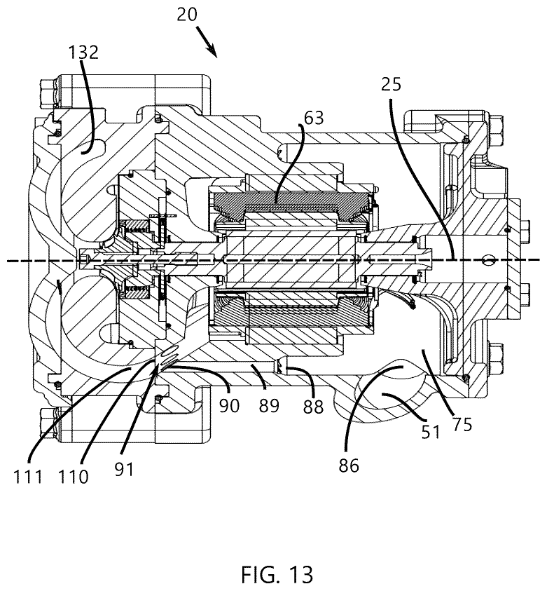

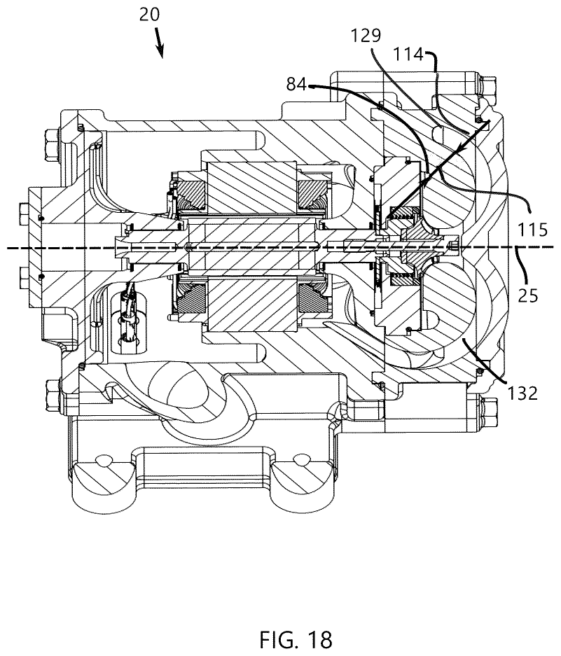

Compressor inlet conduit 111 (see FIG. 13) and compressor inlet conduit 129 (see FIG. 18) have the same geometric relationship to volute 92 and compressor wheel 56 as compressor inlet conduit 73.

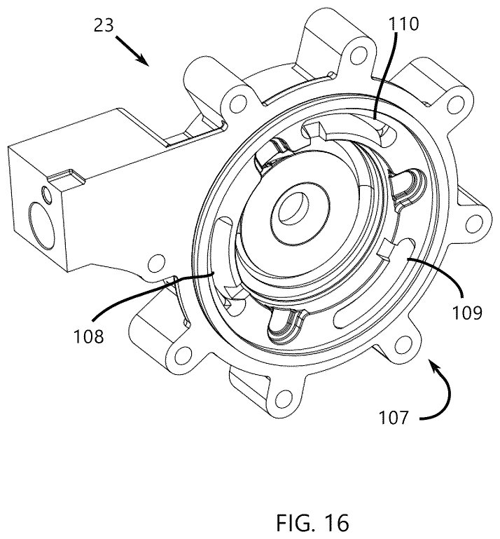

In a plane including both axis of rotation 25 and compressor inlet conduit 111, the compressor conduit including compressor inlet conduit 111 and annular compressor housing conduit 132 (see FIG. 13) extend from arcuate inlet port 110 (see FIG. 16) along a path that passes the axial location of volute region 92 (See FIG. 14) at a distance from axis 25 that is greater than the distance of volute region 92 from axis of rotation 25.

In a plane including both axis of rotation 25 and compressor inlet conduit 129 (See FIG. 16), a compressor conduit including compressor inlet conduit 129 and annular compressor housing conduit 132 extend from arcuate inlet port 108 (see FIG. 16) at a distance from axis 25 that is greater than the distance of volute region 92 from axis of rotation 25.

The path defined by the compressor conduit including compressor inlet conduit 111 and annular compressor housing conduit 132, and the path defined by the compressor conduit including compressor inlet conduit 129 and annular compressor housing conduit 132, from their respective compressor inlet ports to annular compressor wheel inlet 138, execute U-turns, just like the path of the compressor conduit extending from arcuate inlet port 109 to compressor inlet conduit 129.

Arcuate inlet ports 108, 109, and 110 each extends azimuthally around axis of rotation 25 by less than 120 degrees, so that these ports do not overlap with one another, thereby forming distinct ports. (See FIG. 16.) Compressor inlet conduits 73, 111, and 129, where they each join the corresponding arcuate inlet port, have the same azimuthal extent around axis of rotation 25, as that arcuate inlet port.

The azimuthal extent of each one of compressor inlet conduits 73, 111, and 129, increases inside compressor housing 23 with increasing distance from the corresponding arcuate inlet port until each compressor inlet conduit occupies an azimuthal extent of approximately 120 degrees around axis of rotation 25. At the distance from the corresponding arcuate inlet port where each one of compressor inlet conduits 73, 111, and 129 attains an azimuthal extent of approximately 120 degrees around axis of rotation 25, compressor inlet conduits 73, 111, and 129 merge with one another, forming annular compressor housing conduit 132. Annular compressor housing conduit 132 has a cross-section, in a plane perpendicular to axis of rotation 25 that is annular, extending entirely around axis of rotation 25.

Herein, cross-sectional area of annular compressor housing conduit 132 refers generally to the surface area of the outer surface of a conical frustum. Cross-sectional area means the area of a conical frustum obtained by rotating a line segment azimuthally around axis of rotation 25. That line segment extends from a point on the inner surface curve to the closest point thereto on the outer surface curve, wherein the inner surface curve and the outer surface curve represent boundaries of the compressor conduit, as seen in a cross-section extending through axis of rotation 25.

There are two exceptions where the definition of a conical frustum is ambiguous. One exception is where annular compressor housing conduit 132 extends parallel to axis of rotation 25. In this exception, the cross-sectional area of annular compressor housing conduit 132 is the area of the annular section in the plane perpendicular to axis of rotation 25. The other exception is where annular compressor housing conduit 132 extends perpendicular to axis of rotation 25. In this exception, the cross-sectional area of annular compressor housing conduit 132 is the area of a cylindrical surface with a width of the cylindrical surface equal to the distance from the inner surface curve to the outer surface curve. See the discussion of FIG. 19 which shows inner surface curve 123, outer surface curve 124, and line segments that extend from a point on the inner surface curve to the closest point thereto on the outer surface curve, such as the dashed line segment extending through point 119.

Herein, cross-sectional area of a compressor inlet conduit that does not extend entirely around axis of rotation 25, means the surface area within the compressor inlet conduit obtained by rotating the line segment noted above azimuthally around axis of rotation 25 by the azimuthal extent of the compressor inlet conduit.

For clarity, references to cross-sectional area for the compressor conduit, the annular compressor housing conduit 132, the compressor inlet conduits 73, 111, and 129, and the appended claims, refer to the foregoing definitions.

Annular compressor housing conduit 132 extends from where compressor inlet conduits 73, 111, and 129 merge, thereby forming annular compressor housing conduit 132, to annular compressor wheel inlet 138 (See FIGS. 14 and 19). A first portion of annular compressor housing conduit 132 is formed by interior surfaces of compressor housing 23. A second portion of annular compressor housing conduit 132 is formed by opposing surfaces of compressor housing 23 and compressor housing end cap 24. A third portion of annular compressor housing conduit 132 is formed by opposing surfaces of bolt 57 and compressor housing 23. A fourth portion of annular compressor housing conduit 132 is formed by front cylindrical outer surface region 133 of compressor wheel 56 and the opposing inner cylindrical surface region 134 of compressor housing 23.

FIGS. 11 and 12 also illustrate certain fluid bearings.

A fluid bearing uses a fluid as lubricant that separates two surfaces in relative motion. A fluid bearing is otherwise known as an air bearing.

FIG. 12 shows non rotating elements including motor housing 22, compressor housing 23, flat portion 116 of inner surface of compressor housing end cap 24, diffuser plate 62, space 79, front radial fluid bearing section 80, radial bearing conduit 127, non-rotating labyrinth seal part 69 and non-rotating annular part 70. FIG. 12 shows elements of rotatable group 54 including head 58 and shaft 59 of bolt 57, compressor wheel 56, rotatable thrust fluid bearing 66, spacer 67, and rotating labyrinth seal part 68. Compressor wheel 56 has surfaces defining front end 60, vane 71 and peripheral surface 72. Motor rotor section 55 has surfaces defining threaded recess 65. Opposing surfaces of rotating labyrinth seal part 68 and non-rotating labyrinth seal part 69 provide a tortuous path, defining labyrinth seal 61. Labyrinth seal 61 limits, but does not prevent, flow of fluid therethrough due to pressure differential across its ends.

FIG. 12 shows fluid communication path from a high-pressure region near peripheral surface 72 of compressor wheel 56, through labyrinth seal 61, then through compressor wheel leakage conduit 128, to space 79. Peripheral surface 72 of compressor wheel 56 has a thickness along the axial direction between 0.2 to 0.5 millimeters.

FIGS. 11 and 12 show a radially extending rear surface of diffuser plate 62 defining a front surface of space 79, and shows a radially extending front surface region motor housing 22 defining a back surface of space 79. Rotatable thrust fluid bearing 66 resides in space 79, which prevents rotatable group 54 from moving axially relative to motor housing 22, diffuser plate 62, and the other non-rotating elements.

FIG. 12 shows space 79 communicating through radial bearing conduit 127 to a front end of front radial fluid bearing section 80. Front radial fluid bearing section 80 provides fluid communication from radial bearing conduit 127 to central chamber 75. Central chamber 75 is at a relatively low pressure compared to the high-pressure region near peripheral surface 72 of compressor wheel 56.

FIG. 11 shows space 79 communicating via a port in the radially extending front surface region of motor housing 22, to an axially extending portion of first branch 78 of secondary flow inlet conduit 77. The axially extending portion of first branch 78 of secondary flow inlet conduit 77 communicates with a radially extending portion of first branch 78 that extends to unbranched portion of secondary flow inlet conduit 77.

Second branch 81 of secondary flow inlet conduit 77 extends from unbranched portion of secondary flow inlet conduit 77 axially through a rear surface of motor housing 22 and into motor housing end piece 21. In motor housing end piece 21, second branch 81 communicates with bearing flow conduit 82. Bearing flow conduit 82 extends from second branch 81 radially inward towards axis 25 and communicates with axial flow conduit 83. Axial flow conduit 83 is defined by an interior surface of motor housing end cap 64, surfaces of motor housing end piece 21, and surfaces of rotatable group 54.

Axial flow conduit 83 extends axially and communicates with a rear end of rear radial fluid bearing section 87. Rear radial fluid bearing section 87 provides fluid communication from axial flow conduit 83 into central chamber 75.

FIG. 11 shows secondary port 76 along an outer surface of motor housing 22 connecting with secondary flow inlet conduit 77. FIG. 11 shows secondary port 131 along an outer surface of motor housing 22 connecting with bearing flow conduit 82 of motor housing end cap 21.

FIG. 13 illustrates general features of paths for primary fluid flow into and within novel fluid compressor device 20.

FIG. 13 is a section view in the plane defined by section indicators “II-II” in FIG. 4 and passing through axis 25. FIG. 13 shows primary flow inlet conduit 51, central chamber 75, primary flow internal port 86, partial primary flow inlet port 88, partial primary flow conduit 89, partial primary flow outlet port 90, additional partial primary flow outlet ports 91, arcuate inlet port 110 of compressor housing 23, and compressor inlet conduit 111. Surfaces of motor housing 22 define partial primary flow inlet port 88, partial primary flow conduit 89, and partial primary flow outlet port 90.

FIG. 13 shows that fluid entering novel fluid compressor device 20 via primary flow inlet port 52 flows through primary flow inlet conduit 51 and enters central chamber 75 via primary flow internal port 86.

Primary flow internal port 86 opens into central chamber 75 closer to rear end 41 than front end 42 of motor housing 22, further away from compressor housing 23 than partial primary flow inlet port 88, and further away from compressor housing 23 than motor stator section 63.

During operation of novel fluid compressor device 20, relatively low-pressure fluid enters central chamber 75 via primary flow internal port 86 and exits central chamber 75 via partial primary flow inlet ports, such as partial primary flow inlet port 88. The partial primary flow inlet ports are located toward the front of central chamber 75, relative to primary flow internal port 86. Consequently, primary fluid flow in central chamber 75 has an axial component in a direction towards compressor housing 23.

Fluid flows out of central chamber 75 via partial primary flow inlet ports, conduits, and outlet ports, such as partial primary flow inlet port 88, partial primary flow conduit 89, partial primary flow outlet port 90. These partial primary flow inlet ports, conduits, and outlet ports communicate with compressor inlet conduits, such as compressor inlet conduit 73, which allows fluid to flow from the partial primary flow inlet ports, conduits, and outlet ports into compressor inlet conduits, into compressor housing 23 and eventually to compressor wheel 56.

FIG. 14 illustrates primary fluid flow of pressurized fluid from compressor wheel 56 to compressor outlet port 34.

FIG. 14 is a section view in the plane which is perpendicular to axis 25 and passing through compressor housing 23, and defined by section indicators “III-III” in FIG. 6.

FIG. 14 shows compressor wheel 56, compressor housing 23 having internal surfaces defining volute region 92 including smaller section 84 and larger section 85, compressor outlet conduit 33, compressor outlet port 34, compressor inlet conduit 73, compressor inlet conduit 111, and compressor inlet conduit 129. Rotation of compressor wheel 56 pressurizes fluid and urges fluid radially away from axis 25 into volute region 92. Pressurized fluid in volute region 92 is primary flow and flows from larger section 85 to compressor outlet conduit 33 and out of compressor outlet port 34.

FIG. 14 shows volute region 92 extends entirely around axis 25 from smaller section 84 to larger section 85. Larger section 85 communicates with compressor outlet conduit 33. Volute region 92 extends around axis 25 at a distance from axis 25 that is greater than a distance from axis 25 of peripheral surface 72 of compressor wheel 56.

Smaller section 84 refers to that portion of volute region 92 having an angular range of 30 degrees of volute 92 extending azimuthally relative to axis 25, in the clockwise direction, from the location of the confluence of larger section 85 and smaller section 84, that is in the direction away from the confluence. In FIG. 14, the direction away from the confluence region extends from the confluence region to the right side of the figure.

A smaller section of a volute region herein means that section of a volute region extending azimuthally relative to the axis of rotation from the confluence of the larger and smaller sections of the volute region by 30 degrees.

FIG. 14 shows front cylindrical outer surface region 133 of compressor wheel 56 opposing inner cylindrical surface region 134 of compressor housing 23, thereby delimiting the area of annular compressor wheel inlet 138. Annular compressor wheel inlet 138 is at the end of annular compressor housing conduit 132 that terminates at a plane defined points contacted by front edge 137 of vane 71 of compressor wheel 56 when compressor wheel 56 rotates about axis of rotation 25. (See FIG. 19)

FIG. 14 shows front edge 137 of vane 71 extending away from front cylindrical outer surface region 133 of compressor wheel 56 to inner cylindrical surface region 134 of compressor housing 23. FIG. 14 shows front peripheral edge 135 of vane 71 at the same radii from axis of rotation 25 as inner cylindrical surface region 134 of compressor housing 23.

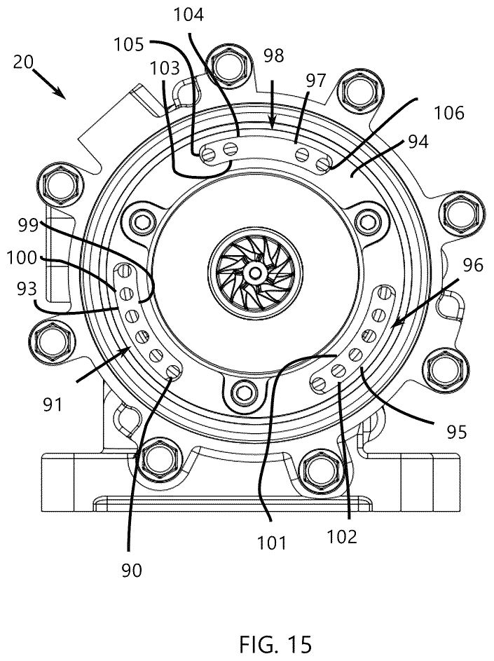

FIG. 15 shows front surface 94 of motor housing 22, partial primary flow outlet port 90, additional partial primary flow outlet ports 91, groove 93, groove 95, six partial primary flow outlet ports 96, groove 97, four partial primary flow outlet ports 98, inner edge 99, outer edge 100, inner edge 101, outer edge 102, inner edge 103, and outer edge 104.

A groove is a region whose surface is depressed relative to adjacent surfaces.

Front surface 94 delimits groove 93 in which connect partial primary flow outlet port 90 and additional partial primary flow outlet ports 91. Front surface 94 delimits groove 95 in which connect six partial primary flow outlet ports 96. Front surface 94 delimits groove 97 in which connect six partial primary flow outlet ports 98. Front surface 94 delimits groove 97 in which connect to four partial primary flow outlet ports 98.

Groove 93 is delimited by inner edge 99 and outer edge 100. Groove 95 is delimited by inner edge 101 and outer edge 102. Groove 97 is delimited by inner edge 103 and outer edge 104. Each one of inner edge 99, inner edge 101, and inner edge 103 extends in an arc defined by the same inner groove radius from axis 25. Each one of outer edge 100, outer edge 102, and outer edge 104 extends in an arc defined by the same outer groove radius from axis 25. Each one of ports 90, 91, 96, 98 extend radially by a length that is less than the difference of the outer groove radius minus the inner groove radius. An arc defined by a radius from axis 25 that has a length that is the average of the outer groove radius and the inner groove radius extends through each one of ports 90, 91, 96, 98.

Groove 97 extends arcuately to first groove end 105 and to second groove end 106. Four partial primary flow outlet ports 98 are unevenly spaced so that a first two ports thereof are closer to one another than to a second two ports thereof, the first two ports are closer to first groove end 105 than a center of groove 97, and the second two ports are closer to second groove end 106 than a center of groove 97.

The inner groove radius of grooves 93, 95, and 97 is greater than a radial extent of space 79.

Each one of additional partial primary flow outlet ports 91 connects a corresponding partial primary flow conduit which terminates at a partial primary flow inlet port communicating with central chamber 75. Each one of partial primary flow outlet ports 96 connects a corresponding partial primary flow conduit which terminates at a partial primary flow inlet port communicating with central chamber 75. Each one of partial primary flow outlet ports 98 connects a corresponding partial primary flow conduit which terminates at a partial primary flow inlet port communicating with central chamber 75. Each one of the partial primary flow inlet ports connects with the central chamber 75 closer to front end 42 than to rear end 41 of compressor housing 22.

FIG. 16 illustrates continuation of fluid flow paths from motor housing 22 into compressor housing 23.

FIG. 16 shows rear surface 107 of compressor housing 23, arcuate inlet port 108, arcuate inlet port 109, and arcuate inlet port 110.

Arcuate inlet port 108 faces groove 97 which provides a path for fluid to flow from groove 97 through arcuate inlet port 108. Arcuate inlet port 109 faces groove 95 which provides a path for fluid to flow from groove 95 through arcuate inlet port 109 into compressor inlet conduit 73. Arcuate inlet port 110 faces groove 93 which provides a path for fluid to flow from groove 93 through arcuate inlet port 110.

Rear surface 107 has edges that define arcuate inlet port 108, arcuate inlet port 109, and arcuate inlet port 110. Each one of arcuate inlet ports 108, 109, and 110 has an inner edge that extends in an arc defined by the same inner groove radius, and an outer edge that extend in an arc defined by the same outer groove radius from axis 25, as grooves 93, 95, and 97. Arcuate inlet ports 108, 109, and 110 each extend to a corresponding compressor inlet conduit.

Arcuate inlet ports 108, 109, and 110 are arranged radially and azimuthally around axis 25 so that they mate with grooves 93, 95, 97. Fluid exiting grooves 93, 95, 97 enters a corresponding compressor inlet conduit, such as compressor inlet conduit 73, which conveys fluid to annular compressor housing conduit 132, which conveys fluid to compressor wheel 56.

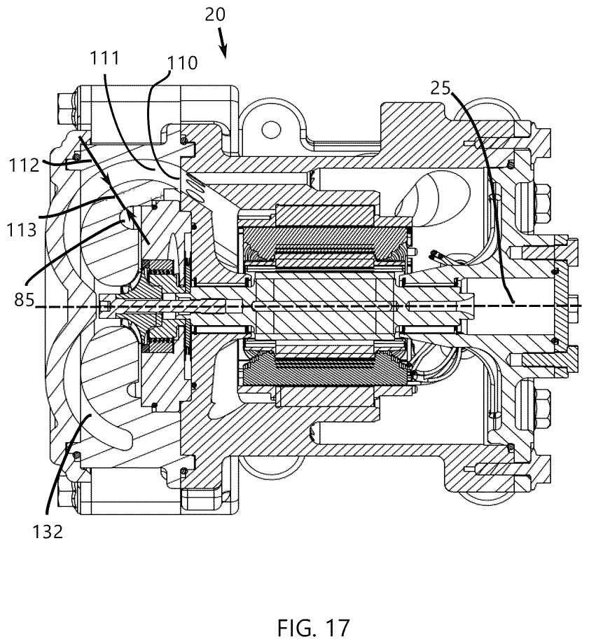

FIGS. 17 and 18 illustrate relative proximity of volute region 92 to compressor inlet conduits including compressor inlet conduit 73.

FIG. 17 shows larger section 85 of volute region 92, compressor inlet conduit 111, annular compressor housing conduit 132, arrows 112, and line segment 113. Arrows 112 and line segment 113 are not structural elements and are shown for purposes of definition of geometric relationships.

Larger section 85 communicates with compressor outlet conduit 33 (see FIG. 14). Arrows 112 and line segment 113 are aligned along an axis and tips of arrows 112 oppose one another, thereby delimiting line segment 113 therebetween. Tips of arrows 112, as well as ends of line segment 113, terminate at points on opposing surfaces of larger section 85 and the conduit including compressor inlet conduit 111 and annular compressor housing conduit 132. Except for its endpoints, line segment 113 is contained within material forming compressor housing 23. The length of line segment 113 is the minimum length between any two points on opposing surfaces of volute 92 and the conduit including compressor inlet conduit 111 and annular compressor housing conduit 132. Line segment 113 has a length of ten (10) millimeters (mm). In other words, the minimum distance between volute region 92 and the conduit including compressor inlet conduit 111 and annular compressor housing conduit 132, is ten (10) millimeters (mm).

FIG. 18 shows smaller section 84 of volute region 92, compressor inlet conduit 129 (see FIG. 13), annular compressor housing conduit 132, arrows 114, and line segment 115. Arrows 114 and line segment 115 are not structural elements and are shown for purposes of definition of geometric relationships.

Arrows 114 and line segment 115 are aligned along an axis and tips of arrows 114 oppose one another, thereby delimiting line segment 115 therebetween. Tips of arrows 114, as well as ends of line segment 115, terminate at points on opposing surfaces of smaller section 84 and the compressor conduit including compressor inlet conduit 73 and annular compressor housing conduit 132. The length of line segment 115 is the minimum length between any two points on opposing surfaces of smaller section 84 and the compressor conduit including compressor inlet conduit 73 and annular compressor housing conduit 132. Except for its endpoints, line segment 115 is within material forming compressor housing 23. Line segment 115 has a length of sixteen (16) millimeters (mm). In other words, the minimum distance between smaller section 84 and the compressor conduit including compressor inlet conduit 73 and annular compressor housing conduit 132 is sixteen (16) millimeters (mm).

FIG. 19 is a magnified portion of the lower left side of the section shown in FIG. 11, which shows a cross-section of the compressor conduit including compressor inlet conduit 73 and annular compressor housing conduit 132. The conduit shows a path for fluid flow from arcuate inlet port 109 to compressor wheel 56. Rotation of compressor wheel 56 rotates vane 71 in a direction that urges fluid to flow from front edge 137 of vane 71 to volute region 92. Dashed lines in FIG. 19 are for illustration only and do not represent structure.

FIG. 19 shows compressor wheel 56, compressor housing 58, compressor inlet conduit 73, arcuate inlet port 109, flat portion 116 of the inner surface of compressor housing end cap 24, cross-section 117 of arcuate inlet port 109, point 118 of center-curve 122, point 119 of center-curve 122, point 120 of center-curve 122, point 121 of center-curve 122, center-curve 122, inner surface curve 123, outer surface curve 124 compressor conduit eye 125, annular compressor housing conduit 132, point 136 of center-curve 122, and front edge 137 of vane 71. Cross-sections and center-curve 122 are represented by dashed lines to aid in describing the geometry and do not represent structural elements.

Cross-section 117 is delimiting by the perimeter of arcuate inlet port 109. The perimeter of arcuate inlet port 109 is defined by an edge formed by a surface region of compressor housing 23 (see FIG. 16) where it meets surfaces of compressor inlet conduit 73. The cross-section of arcuate inlet port 108 and the cross-section of arcuate inlet port 110 are identical in size and shape to cross-section 117 of arcuate inlet port 109.

The sum of the measured area of cross-section 117 of arcuate inlet port 109, the cross-section of arcuate inlet port 108, and the cross-section of arcuate inlet port 110 equals 1326 square millimeters. The cross-section of each one of ports 108, 109, and 110, occupies one third of 1326 square millimeters.

A cross section of the compressor conduit including compressor inlet conduit 73 and annular compressor housing conduit 132 is delimited by inner surface curve 123 and outer surface curve 124. A point on inner surface curve 123 is closer to compressor wheel 56 than an opposing point on outer surface curve 124.

An end of center-curve 122 is a point in cross-section 117. Center-curve 122 extends initially through compressor inlet conduit 73. Center-curve 122 extends past the region where compressor inlet conduits 73, 111, and 129 merge to form annular compressor housing conduit 132. The location along axis of rotation 25 where this merger occurs defines one end of annular compressor housing conduit 132, and is called a merger location. Center-curve 122 extends through annular compressor housing conduit 132 to point 136. Center-curve 122 ends at point 136. Point 136 is coincident with a point on a plane defined by rotation of front edge 137 of vane 71 around axis of rotation 25. This plane defines the annular compressor wheel inlet 138.

FIG. 19 shows a dashed line indicating location of annular compressor wheel inlet 138 and shows point 136 on the dashed line. The dashed line is shown in FIG. 19 slightly offset from front edge 137, only for clarity. As shown in FIGS. 14 and 19, annular compressor wheel inlet 138 extends from front cylindrical outer surface region 133 of compressor wheel 56 to inner cylindrical surface region 134 of compressor housing 23 to thereby define an annular region through which fluid flows past vane 71 as compressor wheel 56 rotates.

Center-curve 122 extends along a center of the cross-section of the compressor conduit including compressor inlet conduit 73 and annular compressor housing conduit 132, from a point at cross-section 117 of arcuate inlet port 109, through point 118, point 119, point 120, point 121 at compressor conduit eye 125, and to point 136 at annular compressor wheel inlet 138.

Point 121 is in a plane perpendicular to axis 25 where axis 25 intersects flat portion 116 of inner surface of compressor housing end cap 24.

For purposes of this application, a center-curve of a compressor inlet conduit, such as center-curve 122, is defined with respect to a cross-section in a plane including axis of rotation 25.

A cross-section of a compressor conduit defines an inner surface curve and an outer surface curve, such as inner surface curve 123 and outer surface curve 124 of the compressor conduit including compressor inlet conduit 73 and annular compressor housing conduit 132.

A center-curve of a compressor conduit is defined by the locus of points halfway from each point on the inner surface curve of the compressor conduit and the corresponding closest point thereto on the outer surface curve of the compressor conduit. Center-curve 122 is defined by the locus of points half way from each point on inner surface curve 123 and the corresponding closest point thereto on outer surface curve 124.

The cross-sectional area for a point on center-curve 122 is the cross-sectional area a plane both (1) passing through that point of center-curve 122 and (2) that is perpendicular to center-curve 122 at that point.

At point 136 of center-curve 122, the component of direction of fluid flow in the conduit containing center-curve 122 that is parallel to axis of rotation 25 points in the backward direction.

At point 121 of center-curve 122, the component of direction of fluid flow in the conduit containing center-curve 122 that is parallel to axis of rotation 25 points in the backward direction.

At point 120 of center-curve 122, the component of direction of fluid flow in the conduit containing center-curve 122 that is parallel to axis of rotation 25 points in the backward direction.

At point 119 of center-curve 122, the component of direction of fluid flow in the conduit containing center-curve 122 that is parallel to axis of rotation 25 points in the forward direction.

At point 118 of center-curve 122, the component of direction of fluid flow in the conduit containing center-curve 122 that is parallel to axis of rotation 25 points in the forward direction.

At points 118, 119, 120, and 121, the component of direction of fluid flow in the conduit containing center-curve 122 that is perpendicular to axis of rotation 25 points towards axis of rotation 25.

At cross-section 117 (at arcuate inlet port 109), the component of direction of fluid flow in the conduit containing center-curve 122 that is perpendicular to axis of rotation 25 points away from axis of rotation 25.

Point 121 is in a plane perpendicular axis 25 that intersects axis 25 where axes 25 contacts flat portion 116 of inner surface of compressor housing end cap 24. Point 121 defines the location of compressor conduit eye 125. Length along center-curve 122 from arcuate inlet port 109 to compressor conduit eye 125 is the compressor conduit eye length.

Center-curve 122 has a starting point at arcuate inlet port 109 and has an ending point at annular compressor wheel inlet 138.

### Measurements of Lengths and Areas

All lengths and cross-sectional areas specified herein for compressor housing conduit lengths and cross-sectional areas are the result of actual measurements either on prototypes or engineering drawings, are not generated from mathematical modeling, and are therefore are subject to some experimental error.

The portion of center-curve 122 from cross-section 117 to compressor conduit eye 125 has a length of 77.6 millimeters.

The entirety of center-curve 122, from cross-section 117 to annular compressor wheel inlet 138, has a length of 85.8 millimeters

Point 118 is located 25 percent of the distance along center-curve 122 from arcuate inlet port 109 to compressor conduit eye 125.

Point 118 is located 22.6 percent of the distance along center-curve 122 from arcuate inlet port 109 to annular compressor wheel inlet 138.

Point 119 is located 50 percent of the distance along center-curve 122 from arcuate inlet port 109 to compressor conduit eye 125.

Point 119 is located 45.2 percent of the distance along center-curve 122 from arcuate inlet port 109 to annular compressor wheel inlet 138.

Point 120 is located 85 percent of the distance along center-curve 122 from arcuate inlet port 109 to compressor conduit eye 125.

Point 120 is located 79.9 percent of the distance along center-curve 122 from arcuate inlet port 109 to annular compressor wheel inlet 138.

Point 121 is located 90.4 percent of the distance along center-curve 122 from arcuate inlet port 109 to annular compressor wheel inlet 138.

At point 118, the total cross-sectional area of all compressor conduits in compressor housing 23 extending from inlet ports communicating from motor housing 22 to annular compressor wheel inlet 138, is 2686 square millimeters. This area is either the sum of cross-sectional areas of compressor inlet conduit 73, compressor inlet conduit 111, and compressor inlet conduit 129, or the cross-sectional area of annular compressor housing conduit 132, depending on which exists in the plane perpendicular to axis of rotation 25 encompassing point 118.

At point 119, the cross-sectional area of annular compressor housing conduit 132 is 1903 square millimeters.

At point 120, the cross-sectional area of annular compressor housing conduit 132 is 485 square millimeters. This is the cross-sectional area of annular compressor wheel inlet 138.

At point 121, the cross-sectional area of annular compressor housing conduit 132 is 117.5 square millimeters. This is the cross-sectional area of annular compressor wheel inlet 138.

At point 136, the cross-sectional area of annular compressor housing conduit 132 is 128.6 square millimeters. This is the cross-sectional area of annular compressor wheel inlet 138.

The minimum distance from the compressor conduit including compressor inlet conduit 73 and annular compressor housing conduit 132, to smaller section 84 of volute region 92, is 16 millimeters.

The minimum distance from the compressor conduit including compressor inlet conduit 111 and annular compressor housing conduit 132, to volute region 92, is 10 millimeters.

### Ratios Related to Total Area of Compressor Inlet Ports 108, 109, 110

A total cross-sectional area of all conduits in compressor housing 23 extending from inlet ports communicating from motor housing 22 to annular compressor wheel inlet 138, at a point 25 percent of the distance along a path through such a conduit, from arcuate inlet port 109 to the compressor conduit eye 125, divided by the sum of the cross-sectional areas of arcuate inlet ports 108, 109, and 110, is 2686 divided by 1326. This value equals 2.03.

The cross-sectional area of annular compressor housing conduit 132 at a point 50 percent of the distance from arcuate inlet port 109 to compressor conduit eye 125, divided by the sum of the cross-sectional areas of arcuate inlet ports 108, 109, and 110, is 1903 divided by 1326. This value equals 1.43.

The cross-sectional area of a compressor inlet conduit at a point 85 percent of the distance from the compressor housing inlet port to the compressor conduit eye 125, divided by the sum of the cross-sectional areas of arcuate inlet ports 108, 109, and 110, is 485 divided by 1326. This value equals 0.366.

### Ratios Related to Area of Compressor Conduit Eye 125

A total cross-sectional area of all conduits in compressor housing 23 extending from inlet ports communicating from motor housing 22 to annular compressor wheel inlet 138, at a point 25 percent of the distance from arcuate inlet port 109 to compressor conduit eye 125, divided by the cross-section of compressor conduit eye 125, is 2686 divided by 117.5, which is about 22.9

A cross-sectional area of annular compressor housing conduit 132 at a point 50 precent of the distance from arcuate inlet port 109 to compressor conduit eye 125, divided by the cross-section of compressor conduit eye 125, is 1903 divided by 117.5, which is about 16.2

A cross-sectional area of annular compressor housing conduit 132 at a point 85 of the distance from arcuate inlet port 109 to compressor conduit eye 125, divided by the cross-section of compressor conduit eye 125, is 485 divided by 117.5, which is about 4.13.

### Ratios to Related to Area of Annular Compressor Wheel Inlet 138

A total cross-sectional area of all conduits in compressor housing 23 extending from inlet ports communicating from motor housing 22 to annular compressor wheel inlet 138, at a point 22.6 percent of the distance from arcuate inlet port 109 to annular compressor wheel inlet 138, divided by the cross-section of annular compressor wheel inlet 138, is 2686 divided by 128.6. This value equals 20.7.

A cross-sectional area of annular compressor housing conduit 132 at a point 45.2 percent of the distance from arcuate inlet port 109 to annular compressor wheel inlet 138, divided by the cross-section of annular compressor wheel inlet 138, is 1903 divided by 128.6. This value equals 14.8.

A cross-sectional area of annular compressor housing conduit 132 at a point 79.9 percent of the distance from arcuate inlet port 109 to annular compressor wheel inlet 138, divided by the cross-section of annular compressor wheel inlet 138, is 485 divided by 128.6. This value equals 3.77.

A cross-sectional area of annular compressor housing conduit 132 at a point 90.4 percent of the distance from arcuate inlet port 109 to annular compressor wheel inlet 138, divided by the cross-section of annular compressor wheel inlet 138, is 117.75 divided by 128.6. This value equals 0.914.

Ratios to Related to Distance from Compressor Inlet Conduit to Volute

A length along center-curve 122 from arcuate inlet port 109 to compressor conduit eye 125, divided by the minimum distance from the compressor conduit including annular compressor housing conduit 132 and compressor inlet conduit 73, to smaller section 84 of volute region 92, is 77.6 millimeters divided by 16 millimeters. This value is 4.85

A length along center-curve 122 from arcuate inlet port 109 to compressor conduit eye 125, divided by the minimum distance from the compressor conduit including annular compressor housing conduit 132 and compressor inlet conduit 111, to volute region 92, is 77.6 millimeters divided by ten millimeters. This value is 7.76.

### Thermodynamic Calculations and Comparative Data

Calculations indicate that temperature of the fluid at annular compressor wheel inlet 138 is at least three degrees Kelvin warmer than fluid at arcuate inlet port 109, during normal operation of novel fluid compressor device 20.

Normal operation of an embodiment of novel fluid compressor device 20 occurred with the following parameters. Pressure at primary flow inlet conduit 51 was measured to be about 5.76 bar, and pressure at compressor outlet port 34 was measured to be 18.0 bar, compressor wheel 56 was rotating at about 150,000 (generally from 100,000 to 160,000) revolutions per minute, the working fluid used was R1234yf; also known as 2,3,3,3-Tetrafluoropropene and as HFO-1234yf refrigerant, the compressor housing 23 was formed from cast aluminum alloy 356, also known by the standard definition ASTMB108, and ambient temperature was 25 Celsius.

Inspection of the compressor wheel of the embodiment of novel fluid compressor device 20, after normal operation, revealed no pitting. In contrast, the compressor wheel of a prototype similar to novel fluid compressor device 20, but lacking structure providing temperature of the fluid at the annular compressor wheel inlet of at least three degrees Kelvin warmer than fluid at the compressor inlet port, resulted in pitting of the compressor wheel.

During normal operation of the tested embodiment of novel fluid compressor device 20, a relatively small flux of fluid compared to the flux of fluid entering primary flow inlet port 52 and compared to the flux of fluid exiting compressor outlet port 34, was forced through secondary flow inlet conduit 77 of motor housing 22 into motor housing 22, resulting in fluid flow through from secondary flow inlet conduit 77, through first branch 78 and second branch 81, to rotatable thrust fluid bearing 66, front radial fluid bearing section 80, and rear radial fluid bearing section 87.

### Variations from the Disclosed Embodiment

Variations from novel fluid compressor device 20 are contemplated. Housing elements may be secured by means other than fasteners. Fasteners 26, 29 need not extend through apertures. For example, fasteners may take the form of clamps or joints. Outer surface structure other than the presence of motor and compressor housings, ports for primary flow inlet and outlet, and electrical feedthroughs, are not required.

Instead of fastener 29 extending through an aperture in radially extended region 31 of compressor housing end cap 24, it may extend through an aperture in radially extended region 130 of motor housing 22, and a recess may exist in compressor housing end cap 24 instead of radially extended region 31 of compressor housing end cap 24. That is, apertures through which fastener 29 extends may be present in the radially extended portions of compressor housing end cap 24, compressor housing 23, and motor housing 22 aligned with fastener 29, or one of the radially extended portions of compressor housing end cap 24 and compressor housing 23 may form a recess instead of an aperture into which fastener 29 is inserted.

Rotor section 55 comprises one or more magnet and stator section that may comprise one or more coil windings. In any case the motor section contains an electric motor designed to provide torque to rotatable group 54.

Certain elements useful in assembly of compressor wheel 56, that may be beneficial for fluid flow and stability, including annular part 70 and spacer 67, are not essential for functioning of compressor wheel 56. Labyrinth seal 61 may be replaced with a non-labyrinth seal.

A separate secondary port, such as secondary port 131, may be used to flow fluid past rear radial fluid bearing section 87, in which case second branch 81 need not communicate with secondary flow inlet conduit 77 and need not be present.

Secondary ports 76 and 131 may be blocked, in which case fluid flows through labyrinth seal 61 along a secondary flow path that bifurcates, with one path leading to the front end of front radial fluid bearing section 80, and through that bearing into central chamber 75, and the other path leading to the rear end of rear radial fluid bearing section 87, and through the bearing into central chamber 75.

Alternatively, one or the other of secondary ports 76 and 131 may be provided a relatively small flux of fluid compared to the flux of primary fluid flow, and at a pressure intermediate between the higher pressure of the fluid at compressor outlet port 34 and the lower pressure at primary flow inlet port 52. In this alternative, fluid flows from one of the other of secondary ports 76 and 131 to the front end of front radial fluid bearing section 80 and to the rear end of rear radial fluid bearing section 87. The relatively small flux of fluid at the intermediate pressure may be generated by splitting off from fluid flowing out of compressor outlet port 34 a relatively small flux of fluid, reducing the pressure in that relatively small flux to a pressure intermediate between the higher pressure of the fluid at compressor outlet port 34 and the lower pressure at primary flow inlet port 52, and introducing that relatively small flux to one of secondary ports 76 and 131.

There may be one, two or more than three grooves instead of three grooves. For example, there may be 4, 5, 6, 7, or 8 grooves. There may be one, two, or more than three compressor inlet conduits instead of three compressor inlet conduits. For example, there may be 4, 5, 6, 7, or 8 compressor inlet conduits. The number of partial primary flow outlet ports in each groove may be between 2 and 100. These ports need not be evenly distributed along an azimuthal angle spanned by the groove in which they reside. When more than 4 partial primary flow outlet ports are present, they may be arranged with centers along more than one radius from axis 25, such as in rows along different arcs, and the centers of ports in different rows may be offset in an azimuthal direction to allow for these ports to be more closely spaced to one another. The depth of each groove may vary from less than the radius of a partial primary flow outlet port, to at least 20 times the radius of each partial primary flow outlet port, and the depth of each groove may vary in the azimuthal direction relative to axis 25. The inner edge and outer edge of each groove need not have an arc with the same radius over the entire length of the edge, so long as the grooves have an arcuate shape allowing for the presence of at least two partial primary flow outlet ports spaced azimuthally from one another to be present in the groove.

The arcuate inlet ports of the compressor housing need not have exactly the same shape as grooves in the compressor housing to which they mate, and need not be arcuate, so long as they provide for passage of fluid from the corresponding groove into a corresponding compressor inlet conduit. For example, the inlet ports into the compressor housing may be circular, rectangular, or may have the inner or outer edge deformed from a fixed radius.

The sum of the cross-sectional area of the compressor conduits, whether compressor inlet conduits, such as conduits 73, 111, and 129, or annular compressor housing conduit 132, at any point along their paths, when divided by any one of the cross-sectional area of a compressor housing inlet port, the cross-sectional area of compressor conduit eye, or the cross-sectional area of the annular compressor wheel inlet, may vary by plus or minus 10, 20, or 30 percent, or more, from the values for the disclosed embodiment, and still provide beneficial effect.

A total cross-sectional area of all compressor conduits in compressor housing 23 extending from inlet ports communicating from the motor housing to the annular compressor wheel inlet, at a point 22.6 percent of the distance from arcuate inlet port to the annular compressor wheel inlet, divided by the cross-section of the annular compressor wheel inlet, may be plus or minus 10, 20, or 30 percent of 20.7. Likewise at 45.2 percent along the center-curve, the value of the division may be plus or minus 10, 20, or 30 percent of 14.8. Likewise at 79.9 percent along the center-curve, the value of the division may be plus or minus 10, 20, or 30 percent of 3.77 Likewise at 90.4 percent along the center-curve, the value of the division may be plus or minus 10, 20, or 30 percent of 0.914.

The total cross-sectional area of all compressor conduits in the compressor housing extending from inlet ports communicating from motor housing to the annular compressor wheel inlet, at a point 25 percent of the distance along a path through one of those compressor conduits from an inlet port to the compressor conduit eye, divided by the sum of the cross-sectional areas of all of the inlet ports, may be within plus or 10, 20, or 30 percent of 2.03.

The cross-sectional area of the annular compressor housing conduit at a point 50 percent of the distance from the compressor housing inlet port to the compressor conduit eye, divided by the sum of the cross-sectional areas of all of the inlet ports, may be within plus or minus 10, 20, or 30 percent of 1.43.

The cross-sectional area of the annular compressor housing conduit at a point 85 percent of the distance from the compressor housing inlet port to the compressor conduit eye, divided by the sum of the cross-sectional areas of all of the inlet ports, may be within plus or minus 10, 20, or 30 percent of 0.366.

The value of the length of a path along a center-line through compressor conduit from compressor housing inlet port to the compressor conduit eye, divided by the minimum distance between the compressor conduit and the volute region, may vary from the disclosed embodiment's value of 7.76 and still provide beneficial effect.

The value of the length of a path along a center-line through compressor conduit from compressor housing inlet port to the compressor conduit eye, divided by the minimum distance between the compressor conduit and the volute region, may be in the range between plus or minus 10, 20, or 30 percent of 7.76.

The value of the length of a path along a center-line through a compressor conduit from compressor housing inlet port to the compressor conduit eye, divided by the minimum distance between the compressor conduit and smaller section 84 of volute region 92, may vary from the disclosed embodiment and still provide beneficial effect.

The value of the length of a path along a center-line through a compressor conduit from compressor housing inlet port to the compressor conduit eye, divided by the minimum distance between the compressor conduit and the smaller section of the volute region, may be between plus or minus 30 percent of 4.85, between plus or minus 20 percent of 4.85, and preferably between plus or minus 10 percent of 4.85.

The location along the axis of rotation where inlet conduits in the compressor housing merge into an annular compressor housing conduit be anywhere before 85 percent of a distance along the center-curve in a conduit from an inlet port to the compressor conduit eye, anywhere before 50 percent of a distance along the center-curve in a conduit from an inlet port to the compressor conduit eye, and anywhere before 25 percent of a distance along the center-curve in a conduit from an inlet port to the compressor conduit eye. The location of the merger may be anywhere in the range that is less than 79.9 percent, less than 45.2 percent, or less than 22.6 percent of a distance along the center-curve in a conduit from an inlet port to the annular compressor wheel inlet. The location of the merger preferably is at least 5 percent of a distance along the center-curve in a conduit from an inlet port to the annular compressor wheel inlet. The merger location may be between 5 percent and 22.6 percent, 5 percent and 45.2 percent, and 5 percent and 79.9 percent a distance along the center-curve in a conduit from an inlet port to the annular compressor wheel inlet.

Further, different ones of inlet conduits may merge with one another at different positions along the axis of rotation, so that some such inlets merge with one another in different planes perpendicular to the axis of rotation.

1. A fluid compressor device for compressing fluid, comprising:
a motor housing having a motor housing rear end and a motor housing front end, and motor housing side surfaces, the motor housing defining a motor housing central chamber;
a compressor housing having a compressor housing rear end and a compressor housing front end;
wherein the motor housing front end faces the compressor housing rear end;
wherein the motor housing and the compressor housing are immovably fixed to one another;
a motor stator section in the motor housing central chamber;
a rotatable group extending along an axis of rotation from the motor housing central chamber into the compressor housing;
wherein the rotatable group is rotatable about the axis of rotation;
wherein the rotatable group comprises a compressor wheel in the compressor housing and a magnet in the motor housing;
wherein the compressor wheel and magnet are constrained to rotate together as the rotatable group rotates;
wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber;
wherein the motor housing and the compressor housing are configured to provide an internal path for fluid to flow from the motor housing central chamber to a compressor housing inlet port on a surface of the compressor housing rear end;
wherein the compressor housing is configured to provide a primary flow outlet path for fluid to flow from the compressor housing inlet port through a compressor conduit to a surface of the compressor wheel, past the surface of the compressor wheel to a volute region, from the volute region into a compressor outlet conduit, and from the compressor outlet conduit through a compressor outlet port to outside fluid compressor device;
wherein the motor housing front end defines a motor housing front surface;
wherein the motor housing front surface has a relatively flat motor housing front surface region and a groove surface region;
wherein the relatively flat motor housing front surface region is relatively flat compared to the groove surface region;
wherein the groove surface region is enclosed by the motor housing front surface region;
wherein the groove surface region defines a groove;
wherein the groove has a groove perimeter where the groove surface region meets the relatively flat motor housing front surface region;
wherein the groove perimeter extends further in a polar, that is azimuthal, direction around the axis of rotation than in a radial direction away from the axis of rotation;
wherein the groove surface region encloses at least two partial primary flow outlet ports in the groove;
wherein each one of the at least two partial primary flow outlet ports extends to a corresponding one of at least two partial primary flow conduits;
wherein each one of the at least two partial primary flow conduits extends to a corresponding one of at least two partial primary flow inlet ports; and
wherein each one of the at least two partial primary flow inlet ports opens to the motor housing central chamber.

2. The device of claim 1, wherein the groove surface region encloses four partial primary flow outlet ports in the groove.

3. The device of claim 1, wherein the groove surface region encloses six partial primary flow outlet ports in the groove.

4. The device of claim 1, wherein the groove perimeter has a groove perimeter inner edge, and the groove perimeter inner edge defines an inner arc at an inner arc radius from the axis of rotation, and the groove perimeter has a groove perimeter outer edge, and the groove perimeter outer edge defines an arc at an outer arc radius from the axis of rotation; and
wherein the outer arc radius is greater than the inner arc radius.

5. A fluid compressor device for compressing fluid, comprising:
a motor housing having a motor housing rear end and a motor housing front end, and motor housing side surfaces, the motor housing defining a motor housing central chamber;
a compressor housing having a compressor housing rear end and a compressor housing front end;
wherein the motor housing front end faces the compressor housing rear end;
wherein the motor housing and the compressor housing are immovably fixed to one another;
a motor stator section in the motor housing central chamber;
a rotatable group extending along an axis of rotation from the motor housing central chamber into the compressor housing;
wherein the rotatable group is rotatable about the axis of rotation;
wherein the rotatable group comprises a compressor wheel in the compressor housing and a magnet in the motor housing;
wherein the compressor wheel and magnet are constrained to rotate together as the rotatable group rotates;
wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber;
wherein the motor housing and the compressor housing are configured to provide an internal path for fluid to flow from the motor housing central chamber to a compressor housing inlet port on a surface of the compressor housing rear end;
wherein the compressor housing is configured to provide a primary flow outlet path for fluid to flow from the compressor housing inlet port through a compressor conduit to a surface of the compressor wheel, past the surface of the compressor wheel to a volute region, from the volute region into a compressor outlet conduit, and from the compressor outlet conduit through a compressor outlet port to outside fluid compressor device;
wherein the compressor conduit extends from the compressor housing inlet port to a forward axial location, wherein the forward axial location is forward of an axial location of the compressor wheel and forward of an axial location of the volute region;
wherein the compressor conduit extends from the forward axial location to a compressor conduit eye, which is where compressor conduit faces the surface of the compressor wheel;
wherein the compressor housing inlet port has a compressor housing inlet port cross-sectional area;
wherein the compressor conduit has a compressor conduit eye length, which is length along a center-curve in the compressor conduit from the compressor housing inlet port to the compressor conduit eye; and
wherein a cross-sectional area of the compressor conduit at a point 85 percent of a way along the compressor conduit eye length from the compressor housing inlet port, divided by the compressor housing inlet port cross-sectional area, is within plus or minus 30 percent of 0.366.

6. The device of claim 5, wherein a cross-sectional area of the compressor conduit at a point 50 percent of a way along the compressor conduit eye length from the compressor housing inlet port, divided by the compressor housing inlet port cross-sectional area, is within plus or minus 30 percent of 1.43.

7. The device of claim 6, wherein a cross-sectional area of the compressor conduit at a point 25 percent of a way along the compressor conduit eye length from the compressor housing inlet port, divided by the compressor housing inlet port cross-sectional area, is within plus or minus 30 percent of 2.3.

8. The device of claim 5, wherein a cross-sectional area of the compressor conduit at a point 85 percent of a way along the compressor conduit eye length from the compressor housing inlet port, divided by the compressor housing inlet port cross-sectional area, is within plus or minus 20 percent of 0.366; wherein a cross-sectional area of the compressor conduit at a point 50 percent of a way along the compressor conduit eye length from the compressor housing inlet port, divided by the compressor housing inlet port cross-sectional area, is within plus or minus 20 percent of 1.43; and wherein a cross-sectional area of the compressor conduit at a point 25 percent of a way along the compressor conduit eye length from the compressor housing inlet port, divided by the compressor housing inlet port cross-sectional area, is within plus or minus 20 percent of 2.3.

9. The device of claim 5, wherein a cross-sectional area of the compressor conduit at a point 85 percent of a way along the compressor conduit eye length from the compressor housing inlet port, divided by the compressor housing inlet port cross-sectional area, is within plus or minus 10 percent of 0.366; wherein a cross-sectional area of the compressor conduit at a point 50 percent of a way along the compressor conduit eye length from the compressor housing inlet port, divided by the compressor housing inlet port cross-sectional area, is within plus or minus 10 percent of 1.43; and wherein a cross-sectional area of the compressor conduit at a point 25 percent of a way along the compressor conduit eye length from the compressor housing inlet port, divided by the compressor housing inlet port cross-sectional area, is within plus or minus 10 percent of 2.3.

10. The device of claim 5, wherein the compressor housing inlet port has a cross-section that is arcuate.

11. The device of claim 5, wherein the motor housing front end defines a motor housing front surface that includes a groove surface region that defines a groove having a groove perimeter, and wherein the groove perimeter and a perimeter of the compressor housing inlet port have a same shape, and the groove and the compressor housing inlet port mate to one another.

12. A fluid compressor device for compressing fluid, comprising:
a motor housing having a motor housing rear end and a motor housing front end, and motor housing side surfaces, the motor housing defining a motor housing central chamber;
a compressor housing having a compressor housing rear end and a compressor housing front end;
wherein the motor housing front end faces the compressor housing rear end;
wherein the motor housing and the compressor housing are immovably fixed to one another;
a motor stator section in the motor housing central chamber;
a rotatable group extending along an axis of rotation from the motor housing central chamber into the compressor housing;
wherein the rotatable group is rotatable about the axis of rotation;
wherein the rotatable group comprises a compressor wheel in the compressor housing and a magnet in the motor housing;
wherein the compressor wheel and magnet are constrained to rotate together as the rotatable group rotates;
wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber;
wherein the motor housing and the compressor housing are configured to provide an internal path for fluid to flow from the motor housing central chamber to a compressor housing inlet port on a surface of the compressor housing rear end;
wherein the compressor housing is configured to provide a primary flow outlet path for fluid to flow from the compressor housing inlet port through a compressor inlet conduit to a surface of the compressor wheel, past the surface of the compressor wheel to a volute region, from the volute region into a compressor outlet conduit, and from the compressor outlet conduit through a compressor outlet port to outside fluid compressor device;
wherein the compressor inlet conduit extends from the compressor housing inlet port to a forward axial location, wherein the forward axial location is forward of an axial location of the compressor wheel and forward of an axial location of the volute region;
wherein the compressor inlet conduit extends from the forward axial location to a compressor conduit eye, which is where compressor inlet conduit faces the surface of the compressor wheel;
wherein the compressor conduit has a compressor conduit eye length, which is length along a center-curve in the compressor conduit from the compressor housing inlet port to the compressor conduit eye;
wherein a volute region to conduit distance is a minimum distance between a surface of the volute region and a surface of the compressor conduit; and
wherein the compressor conduit eye length, divided by the volute region to conduit distance, is between plus or minus 30 percent of 7.76.

13. The device of claim 12, wherein the compressor conduit eye length, divided by the volute region to conduit distance, is between plus or minus 20 percent of 7.76.

14. The device of claim 12, wherein the compressor conduit eye length, divided by the volute region to conduit distance, is between plus or minus 10 percent of 7.76.

15. The device of claim 12, wherein a smallest volute region to conduit distance is a minimum distance between the compressor conduit and a smaller section of the volute region; and
wherein the compressor conduit eye length, divided by the smallest volute region to conduit distance, is between plus or minus 30 percent of 4.85.

16. The device of claim 15, wherein the compressor conduit eye length, divided by the smallest volute region to conduit distance, is between plus or minus 30 percent of 4.85.

17. The device of claim 15, wherein the compressor conduit eye length, divided by the smallest volute region to conduit distance, is between plus or minus 30 percent of 4.85.

18. A fluid compressor device for compressing fluid, comprising:
a motor housing having a motor housing rear end and a motor housing front end, and motor housing side surfaces, the motor housing defining a motor housing central chamber;
a compressor housing having a compressor housing rear end and a compressor housing front end;
wherein the motor housing front end faces the compressor housing rear end;
wherein the motor housing and the compressor housing are immovably fixed to one another;
a motor stator section in the motor housing central chamber;
a rotatable group extending along an axis of rotation from the motor housing central chamber into the compressor housing;
wherein the rotatable group is rotatable about the axis of rotation;
wherein the rotatable group comprises a compressor wheel in the compressor housing and a magnet in the motor housing;
wherein the compressor wheel and magnet are constrained to rotate together as the rotatable group rotates;
wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber;
wherein the motor housing and the compressor housing are configured to provide an internal path for fluid to flow from the motor housing central chamber to a compressor housing inlet port on a surface of the compressor housing rear end;
wherein the compressor housing is configured to provide a primary flow outlet path for fluid to flow from the compressor housing inlet port through a compressor conduit to a surface of the compressor wheel, past the surface of the compressor wheel to a volute region, from the volute region into a compressor outlet conduit, and from the compressor outlet conduit through a compressor outlet port to outside fluid compressor device;
wherein the internal path comprises at least one primary flow outlet port that opens to the motor housing central chamber at a location that is forward of the primary flow internal port;
wherein the compressor conduit extends from the compressor housing inlet port to a forward axial location, wherein the forward axial location is forward of an axial location of the compressor wheel and forward of an axial location of the volute region;
wherein the compressor conduit extends from the forward axial location to a compressor conduit eye, which is where compressor conduit faces the surface of the compressor wheel;
further comprising structure defining a secondary flow path for fluid flow passing from a front end of a first seal to a rear end of the first seal;
wherein the front end of the first seal is rear of where the compressor conduit faces the surface of the compressor wheel;
wherein the first seal is defined by opposing surface of a first seal part and a second seal part, wherein the first seal part is part of the rotating group and is constrained to rotate with the rotating group and the second seal part is a non-rotating seal part that does not rotate;
wherein a first branch of the secondary flow path extends from the rear end of the first seal to a front end of a front radial fluid bearing, through the front radial fluid bearing, and to a rear end of the front radial fluid bearing which opens to the motor housing central chamber;
wherein a second branch of the secondary flow path extends from the first seal to a rear end of a rear radial fluid bearing, through the rear radial fluid bearing, to a front end of the rear radial fluid bearing which opens to the motor housing central chamber; and
wherein the rear radial fluid bearing is closer to the motor housing rear end than the front radial fluid bearing.

19. The device of claim 18, wherein the first seal defines a labyrinth seal.

20. The device of claim 18, wherein the secondary flow path passes through a chamber containing a rotatable thrust fluid bearing,
wherein the rotatable thrust fluid bearing is a part of the rotating group and is constrained to rotate with the rotatable group, and
wherein the secondary flow path passes through the chamber containing the rotatable thrust fluid bearing before branching into the first branch and the second branch.

21. A fluid compressor device for compressing fluid, comprising:
a motor housing having a motor housing rear end and a motor housing front end, and motor housing side surfaces, the motor housing defining a motor housing central chamber;
a compressor housing having a compressor housing rear end and a compressor housing front end;
wherein the motor housing front end faces the compressor housing rear end;
wherein the motor housing and the compressor housing are immovably fixed to one another;
a motor stator section in the motor housing central chamber;
a rotatable group extending along an axis of rotation from the motor housing central chamber into the compressor housing;
wherein the rotatable group is rotatable about the axis of rotation;
wherein the rotatable group comprises a compressor wheel in the compressor housing and a magnet in the motor housing;
wherein the compressor wheel and magnet are constrained to rotate together as the rotatable group rotates;
wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber;
wherein the motor housing and the compressor housing are configured to provide an internal path for fluid to flow from the motor housing central chamber to a compressor housing inlet port on a surface of the compressor housing rear end;
wherein the compressor housing is configured to provide a primary flow outlet path for fluid to flow from the compressor housing inlet port through a compressor conduit to a surface of the compressor wheel, past the surface of the compressor wheel to a volute region, from the volute region into a compressor outlet conduit, and from the compressor outlet conduit through a compressor outlet port to outside fluid compressor device;
wherein the compressor housing front end comprises a compressor housing end cap;
wherein the compressor housing end cap comprises a plurality of compressor housing end cap radially extended regions;
wherein the compressor housing rear end comprises a plurality of compressor housing rear end radially extended regions;
wherein the motor housing front end comprises a plurality of motor housing front end radially extended regions;
wherein a first one of the plurality of compressor housing end cap radially extended regions has a surface region that defines a first end cap fastener region;
wherein the first end cap fastener region forms either an aperture or a recess extending along a first fastener axis;
wherein the first fastener axis is parallel to the axis of rotation;
wherein a first one of the plurality of compressor housing rear end radially extended regions has a surface region that defines a first compressor housing rear end fastener region;
wherein the first compressor housing fastener rear end fastener region forms an aperture extending along the first fastener axis;
wherein a first one of the plurality of motor housing front end radially extended regions has a surface region that defines a first motor housing front end fastener region; and
wherein the first motor housing front end fastener region defines either an aperture or recess extending along the first fastener axis.

22. The fluid compressor device of claim 21, further comprising a first fastener extending within the first end cap fastener region, the first compressor housing rear end fastener region, and the first motor housing front end fastener region.

23. The fluid compressor device of claim 22, wherein a second one of the plurality of compressor housing end cap radially extended regions has a surface region that defines a second end cap fastener region;
wherein the second end cap fastener region forms either an aperture or a recess extending along a second fastener axis;
wherein the second fastener axis is parallel to the axis of rotation;
wherein a second one of the plurality of compressor housing rear end radially extended regions has a surface region that defines a second compressor housing rear end fastener region;
wherein the second compressor housing fastener rear end fastener region forms an aperture extending along the second fastener axis;
wherein a second one of the plurality of motor housing front end radially extended regions has a surface region that defines a second motor housing front end fastener region;
wherein the second motor housing front end fastener region defines either an aperture or recess extending along the second fastener axis; and
further comprising a second fastener extending within the second end cap fastener region, the second compressor housing rear end fastener region, and the second motor housing front end fastener region.

24. A fluid compressor device for compressing fluid, comprising:
a motor housing having a motor housing rear end and a motor housing front end, and motor housing side surfaces, the motor housing defining a motor housing central chamber;
a compressor housing having a compressor housing rear end and a compressor housing front end;
wherein the motor housing front end faces the compressor housing rear end;
wherein the motor housing and the compressor housing are immovably fixed to one another;
a motor stator section in the motor housing central chamber;
a rotatable group extending along an axis of rotation from the motor housing central chamber into the compressor housing;
wherein the rotatable group is rotatable about the axis of rotation;
wherein the rotatable group comprises a compressor wheel in the compressor housing and a magnet in the motor housing;
wherein the compressor wheel and magnet are constrained to rotate together as the rotatable group rotates;
wherein the motor housing is configured to provide a primary flow inlet path for fluid to flow from outside the fluid compressor device via a primary flow inlet port at an outer surface of the motor housing, through a primary flow inlet conduit in the motor housing to a primary flow internal port at a surface of the motor housing central chamber, and through the primary flow internal port into the motor housing central chamber;
wherein the motor housing and the compressor housing are configured to provide an internal path for fluid to flow from the motor housing central chamber to a compressor housing inlet port on a surface of the compressor housing rear end;
wherein the compressor housing is configured to provide a primary flow outlet path for fluid to flow from the compressor housing inlet port through a compressor conduit to a surface of the compressor wheel, past the surface of the compressor wheel to a volute region, from the volute region into a compressor outlet conduit, and from the compressor outlet conduit through a compressor outlet port to outside fluid compressor device;
wherein the compressor wheel comprises a vane;
wherein the vane comprises front edge;
wherein the front edge of the vane sweeps across a surface that defines an annular compressor wheel inlet, when the compressor wheel rotates 360 degrees;
wherein the compressor conduit extends from the compressor housing inlet port to a forward axial location, wherein the forward axial location is forward of an axial location of the compressor wheel and forward of an axial location of the volute region;
wherein the compressor conduit extends from the forward axial location to the annular compressor wheel inlet;
wherein the compressor conduit comprises a compressor inlet conduit portion and an annular compressor housing conduit portion;
wherein the compressor inlet conduit portion extends from the compressor housing inlet port to a merger location with the annular compressor housing conduit portion such that a path within the compressor conduit exists from the compressor inlet conduit portion into the annular compressor housing conduit portion;
wherein the compressor inlet conduit portion has an azimuthal extent about the axis of rotation that is less than one circle, that is less than 360 degrees; and
wherein the annular compressor housing conduit portion has an azimuthal extent about the axis of rotation that is one circle, that is equal to 360 degrees.

25. The fluid compressor device of claim 24, wherein, in a section of the fluid compressor device passing through the axis of rotation and through compressor housing inlet port, the merger location is less than 79.9 percent of a distance along a center-curve extending through the compressor conduit from the compressor housing inlet port to the annular compressor wheel inlet.

26. The fluid compressor device of claim 24, wherein, in a section of the fluid compressor device passing through the axis of rotation and through compressor housing inlet port, the merger location is less than 45.2 percent of a distance along a center-curve extending through the compressor conduit from the compressor housing inlet port to the annular compressor wheel inlet.

27. The fluid compressor device of claim 24, wherein, in a section of the fluid compressor device passing through the axis of rotation and through compressor housing inlet port, the merger location is less than 22.6 percent of a distance along a center-curve extending through the compressor conduit from the compressor housing inlet port to the annular compressor wheel inlet.

28. The fluid compressor device of claim 24, wherein, in a section of the fluid compressor device passing through the axis of rotation and through compressor housing inlet port, the merger location is at least 5 percent of a distance along a center-curve extending through the compressor conduit from the compressor housing inlet port to the annular compressor wheel inlet.

29. The fluid compressor device of claim 24, wherein, a cross-sectional area of the annular compressor housing conduit portion at a distance 79.9 percent of a distance along a center-curve extending through the compressor conduit from the compressor housing inlet port to the annular compressor wheel inlet, divided by the area of annular compressor wheel inlet, is within plus or minus 30 percent of 3.77.

30. The fluid compressor device of claim 24, wherein, a cross-sectional area of the annular compressor housing conduit portion at a distance 45.2 percent of a distance along a center-curve extending through the compressor conduit from the compressor housing inlet port to the annular compressor wheel inlet, divided by the area of annular compressor wheel inlet, is within plus or minus 30 percent of 14.8.

31. The fluid compressor device of claim 24, wherein, a total cross-sectional area of all compressor conduits in the compressor housing extending from inlet ports communicating from the motor housing to the annular compressor wheel inlet at a distance 22.6 percent of a distance along a center-curve extending through the compressor conduit from the compressor housing inlet port to the annular compressor wheel inlet, divided by the area of annular compressor wheel inlet, is within plus or minus 30 percent of 22.6.
